(19) United States
(12) Patent Application Publication
(10) Pub. No.: US 2024/0406507 A1
(43) Pub. Date: Dec. 5, 2024

(54) USER INTERFACES FOR CONTENT ITEMS ON MOBILE DEVICES

(71) Applicant: Apple Inc., Cupertino, CA (US)

(72) Inventors: Andrew J. LEUNG, Los Angeles, CA (US); Ilanit ESHEL-KROHN, San Jose, CA (US)

(21) Appl. No.: 18/676,357

(22) Filed: May 28, 2024

Related U.S. Application Data
(60) Provisional application No. 63/506,108, filed on Jun. 4, 2023.

(51) Int. Cl. H04N 21/472

(52) U.S. Cl. CPC H04N 21/47217

(57) ABSTRACT

In some embodiments, an electronic device displays a user interface element with information about a content item playing or paused using a content application in a user interface of the content application. In some embodiments, the electronic device displays the user interface element in multiple user interfaces of the content application.

### CROSS-REFERENCE TO RELATED APPLICATIONS

This application claims the benefit of U.S. Provisional Application No. 63/506,108, filed Jun. 4, 2023, the entire disclosure of which is herein incorporated by reference for all purposes.

### FIELD OF THE DISCLOSURE

This disclosure relates generally to user interfaces presenting playback information and controls related to content items.

### BACKGROUND OF THE DISCLOSURE

User interaction with electronic devices has increased significantly in recent years. These devices can be devices such as computers, tablet computers, televisions, multimedia devices, or mobile devices. In some circumstances, users want to view information about content items and control playback of content items using an electronic device.

### SUMMARY OF THE DISCLOSURE

Providing efficient ways of presenting content to a user via a maps application of an electronic device may improve the user's experience with the electronic device and reduce the number of inputs needed to view relevant information in a content playback (e.g., music) application, thereby reducing power usage and improving the battery life of the electronic device.

In some embodiments, an electronic device displays a user interface element with information about a content item playing or paused using a content application. The full descriptions of the embodiments are provided in the Drawings and the Detailed Description, and it is understood that the Summary provided above does not limit the scope of the disclosure in any way.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 5C-5D illustrate exemplary components of a personal electronic device having a touch-sensitive display and intensity sensors in accordance with some embodiments.

FIGS. 5E-5H illustrate exemplary components and user interfaces of a personal electronic device in accordance with some embodiments.

FIGS. 6A-6P illustrate examples of an electronic device displaying a user interface element with information about a content item playing or paused using a content application according to some embodiments of the disclosure.

FIG. 7 is a flow diagram illustrating a method in which an electronic device displays a user interface element with information about a content item playing or paused using a content application according to some embodiments of the disclosure.

### DETAILED DESCRIPTION

In the following description of embodiments, reference is made to the accompanying drawings which form a part hereof, and in which it is shown by way of illustration specific embodiments that are optionally practiced. It is to be understood that other embodiments are optionally used and structural changes are optionally made without departing from the scope of the disclosed embodiments.

There is a need for content applications that include information about a content item playing or paused using the content application in multiple user interfaces of the content application. In some embodiments, an electronic device displays a user interface element including an indication of a playback state of a content item and a playback position of the content item in one or more user interfaces of the content application. In some embodiments, in response to receiving an input selecting the user interface element, the electronic device displays a user interface that includes additional information and controls for the content item without displaying the user interface element. Displaying the user interface element in one or more user interfaces of the content application enhances user interactions with the electronic device by providing more information without requiring additional inputs.

Although the following description uses terms “first,” “second,” etc. to describe various elements, these elements should not be limited by the terms. These terms are only used to distinguish one element from another. For example, a first touch could be termed a second touch, and, similarly, a second touch could be termed a first touch, without departing from the scope of the various described embodiments. The first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

### Exemplary Devices

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touch pads), are, optionally, used. It should also be understood that, in some embodiments, the device is not a portable communications device, but is a desktop computer or a television with a touch-sensitive surface (e.g., a touch screen display and/or a touch pad). In some embodiments, the device does not have a touch screen display and/or a touch pad, but rather is capable of outputting display information (such as the user interfaces of the disclosure) for display on a separate display device, and capable of receiving input information from a separate input device having one or more input mechanisms (such as one or more buttons, a touch screen display and/or a touch pad). In some embodiments, the device has a display, but is capable of receiving input information from a separate input device having one or more input mechanisms (such as one or more buttons, a touch screen display and/or a touch pad). In some embodiments, the electronic device is a computer system that is in communication (e.g., via wireless communication, via wired communication) with a display generation component (e.g., a display device such as a head-mounted device (HMD), a display, a projector, a touch-sensitive display, or other device or component that presents visual content to a user, for example on or in the display generation component itself or produced from the display generation component and visible elsewhere). The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse and/or a joystick. Further, as described above, it should be understood that the described electronic device, display and touch-sensitive surface are optionally distributed amongst two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

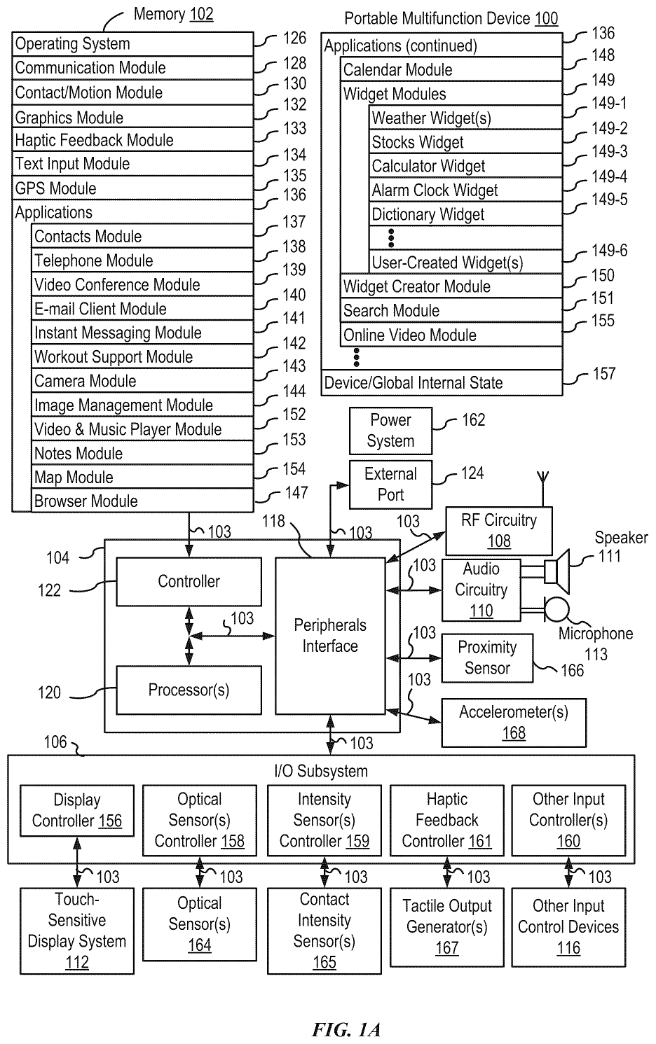

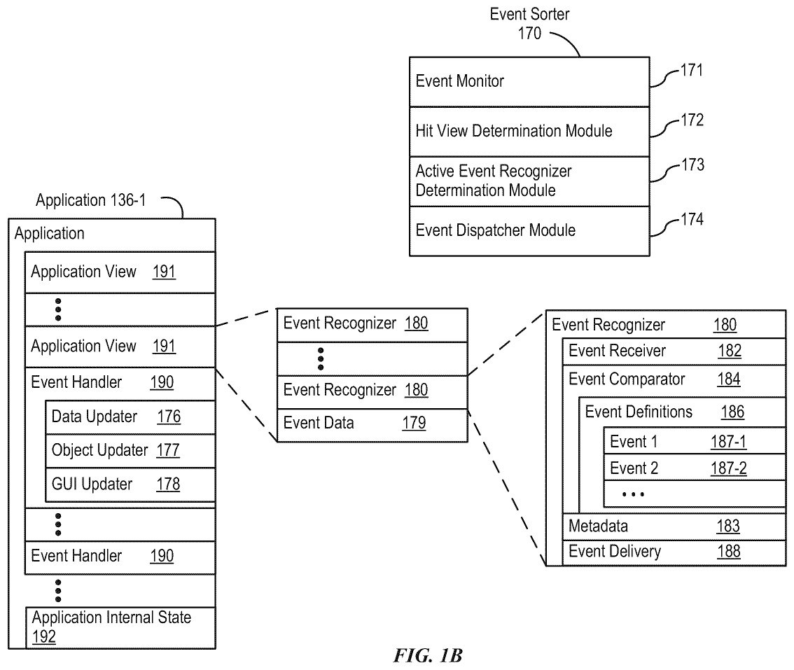

Attention is now directed toward embodiments of portable or non-portable devices with touch-sensitive displays, though the devices need not include touch-sensitive displays or displays in general, as described above. FIG. 1A is a block diagram illustrating portable or non-portable multifunction device 100 with touch-sensitive displays 112 in accordance with some embodiments. Touch-sensitive display 112 is sometimes called a “touch screen” for convenience, and is sometimes known as or called a touch-sensitive display system. Device 100 includes memory 102 (which optionally includes one or more computer readable storage mediums), memory controller 122, one or more processing units (CPU's) 120, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as a “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable or non-portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application specific integrated circuits. Further, the various components shown in FIG. 1A are optionally implemented across two or more devices; for example, a display and audio circuitry on a display device, a touch-sensitive surface on an input device, and remaining components on device 100. In such an embodiment, device 100 optionally communicates with the display device and/or the input device to facilitate operation of the system, as described in the disclosure, and the various components described herein that relate to display and/or input remain in device 100, or are optionally included in the display and/or input device, as appropriate.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs and/or sets of instructions stored in memory 102 to perform various functions for device 100 and to process data.

In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

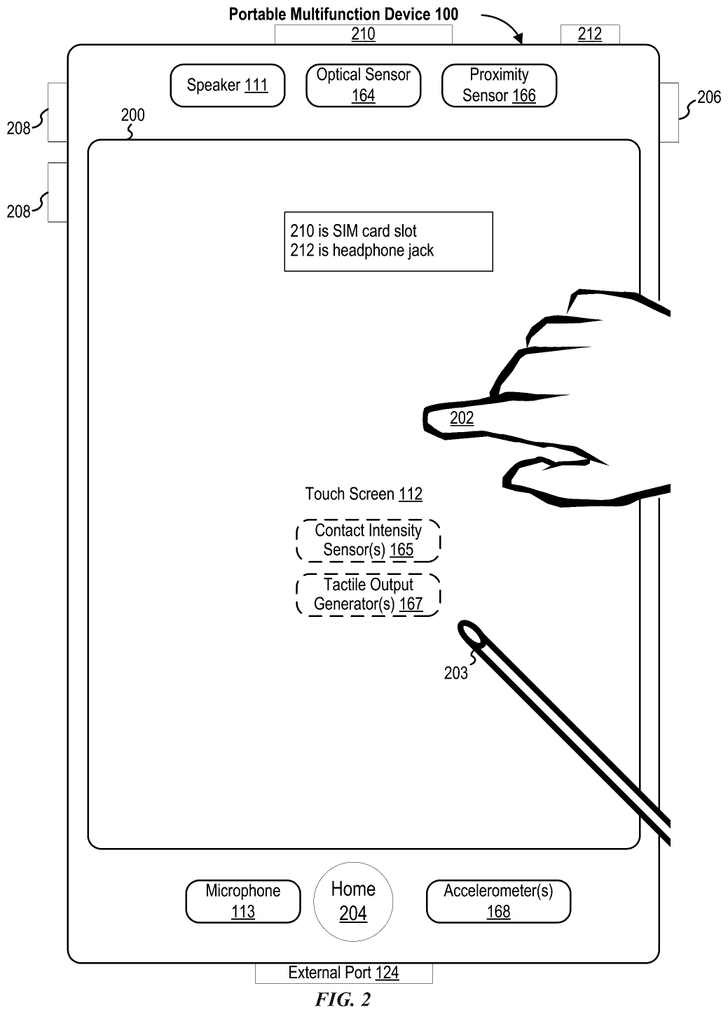

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both cars) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, intensity sensor controller 159, haptic feedback controller 161 and one or more input controllers 160 for other input or control devices. The one or more input controllers 160 receive/send electrical signals from/to other input or control devices 116. The other input control devices 116 optionally include physical buttons (e.g., push buttons, rocker buttons, etc.), dials, slider switches, joysticks, click wheels, and so forth. In some alternate embodiments, input controller(s) 160 are, optionally, coupled to any (or none) of the following: a keyboard, infrared port, USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. As described above, the touch-sensitive operation and the display operation of touch-sensitive display 112 are optionally separated from each other, such that a display device is used for display purposes and a touch-sensitive surface (whether display or not) is used for input detection purposes, and the described components and functions are modified accordingly. However, for simplicity, the following description is provided with reference to a touch-sensitive display. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output corresponds to user-interface objects.

Touch screen 112 has a touch-sensitive surface, sensor or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone®, iPod Touch®, and iPad® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad (not shown) for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable or non-portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112 which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's car (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112 which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer (not shown) and a GPS (or GLONASS or other global navigation system) receiver (not shown) for obtaining information concerning the location and orientation (e.g., portrait or landscape) of device 100.

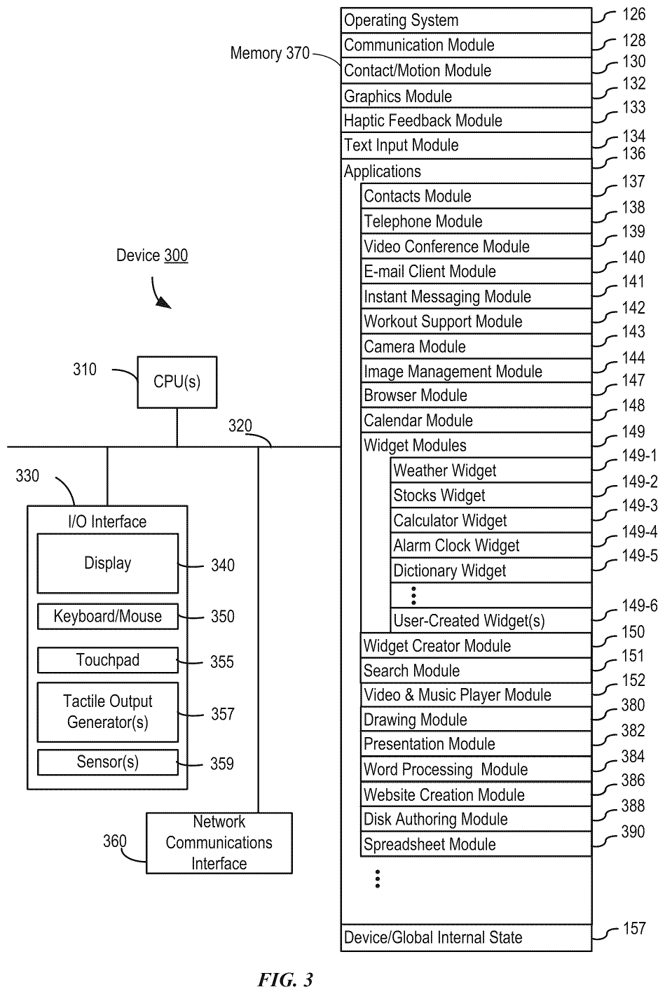

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used on iPod (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact) determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast or other visual property) of graphics that are displayed. As used herein, the term “graphics” includes any object that can be displayed to a user, including without limitation text, web pages, icons (such as user-interface objects including soft keys), digital images, videos, animations and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing, to camera 143 as picture/video metadata, and to applications that provide location-based services such as weather widgets, local yellow page widgets, and map/navigation widgets).

Applications 136 optionally include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
workout support module 142;
camera module 143 for still and/or video images;
image management module 144;
video player module;
music player module;
browser module 147;
calendar module 148;
widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which merges video player module and music player module;
notes module 153;
map module 154; and/or
online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (187) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable or non-portable multifunction device 100 having a touch screen 112 in accordance with some embodiments. As stated above, multifunction device 100 is described as having the various illustrated structures (such as touch screen 112, speaker 111, accelerometer 168, microphone 113, etc.); however, it is understood that these structures optionally reside on separate devices. For example, display-related structures (e.g., display, speaker, etc.) and/or functions optionally reside on a separate display device, input-related structures (e.g., touch-sensitive surface, microphone, accelerometer, etc.) and/or functions optionally reside on a separate input device, and remaining structures and/or functions optionally reside on multifunction device 100.

The touch screen 112 optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also includes one or more physical buttons, such as “home” or menu button 204. As previously described, menu button 204 is, optionally, used to navigate to any application 136 in a set of applications that are, optionally executed on device 100. Alternatively, in some embodiments, the menu button is implemented as a soft key in a GUI displayed on touch screen 112.

In one embodiment, device 100 includes touch screen 112, menu button 204, push button 206 for powering the device on/off and locking the device, volume adjustment button(s) 208, Subscriber Identity Module (SIM) card slot 210, head set jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not include the display and the touch-sensitive surface, as described above, but rather, in some embodiments, optionally communicates with the display and the touch-sensitive surface on other devices. Additionally, device 300 need not be portable. In some embodiments, device 300 is a laptop computer, a desktop computer, a tablet computer, a multimedia player device (such as a television or a set-top box), a navigation device, an educational device (such as a child's learning toy), a gaming system, or a control device (e.g., a home or industrial controller). Device 300 typically includes one or more processing units (CPU's) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable or non-portable multifunction device 100 (FIG. 1A), or a subset thereof. Furthermore, memory 370 optionally stores additional programs, modules, and data structures not present in memory 102 of portable or non-portable multifunction device 100. For example, memory 370 of device 300 optionally stores drawing module 380, presentation module 382, word processing module 384, website creation module 386, disk authoring module 388, and/or spreadsheet module 390, while memory 102 of portable or non-portable multifunction device 100 (FIG. 1A) optionally does not store these modules.

Each of the above identified elements in FIG. 3 are, optionally, stored in one or more of the previously mentioned memory devices. Each of the above identified modules corresponds to a set of instructions for performing a function described above. The above identified modules or programs (e.g., sets of instructions) need not be implemented as separate software programs, procedures or modules, and thus various subsets of these modules are, optionally, combined or otherwise re-arranged in various embodiments. In some embodiments, memory 370 optionally stores a subset of the modules and data structures identified above. Furthermore, memory 370 optionally stores additional modules and data structures not described above.

Attention is now directed towards embodiments of user interfaces that are, optionally, implemented on, for example, portable multifunction device 100.

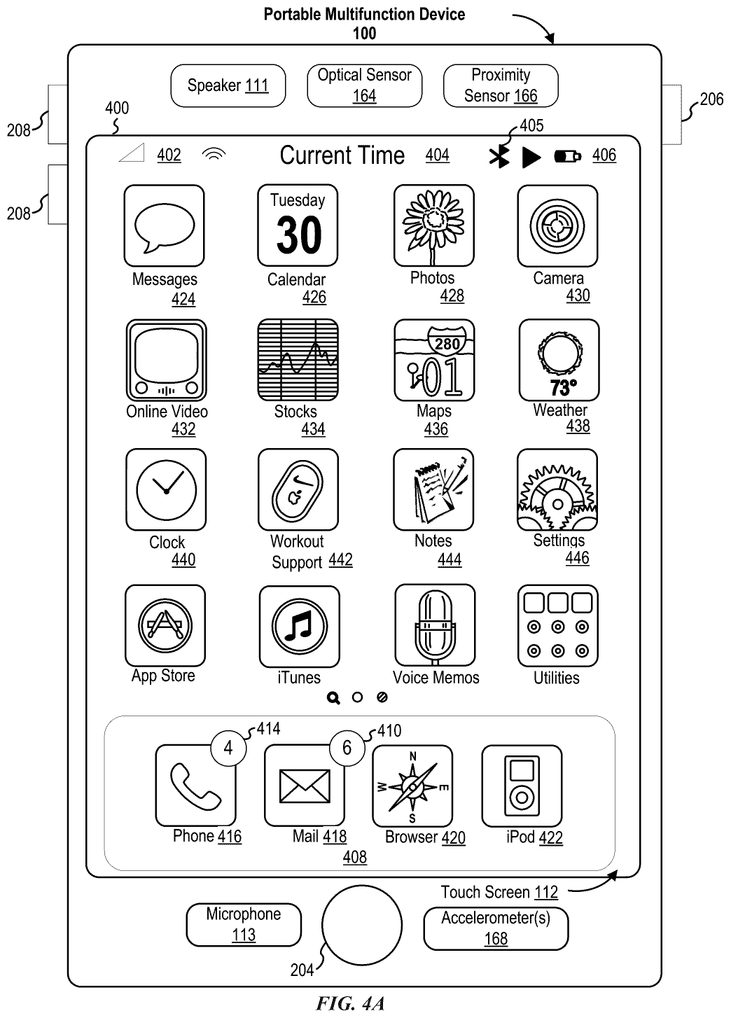

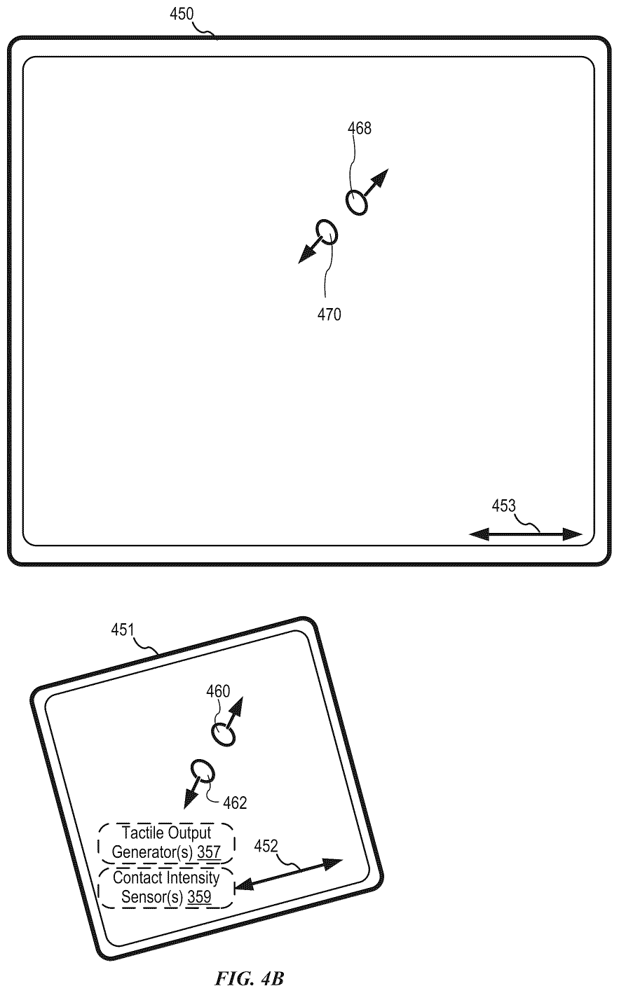

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

As used herein, the term “focus selector” refers to an input element that indicates a current part of a user interface with which a user is interacting. In some implementations that include a cursor or other location marker, the cursor acts as a “focus selector,” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider or other user interface element), the particular user interface element is adjusted in accordance with the detected input. In some implementations that include a touch-screen display (e.g., touch-sensitive display system 112 in FIG. 1A) that enables direct interaction with user interface elements on the touch-screen display, a detected contact on the touch-screen acts as a “focus selector,” so that when an input (e.g., a press input by the contact) is detected on the touch-screen display at a location of a particular user interface element (e.g., a button, window, slider or other user interface element), the particular user interface element is adjusted in accordance with the detected input. In some implementations focus is moved from one region of a user interface to another region of the user interface without corresponding movement of a cursor or movement of a contact on a touch-screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch-screen display) that is controlled by the user so as to communicate the user's intended interaction with the user interface (e.g., by indicating, to the device, the element of the user interface with which the user is intending to interact). For example, the location of a focus selector (e.g., a cursor, a contact or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90% or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the description of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

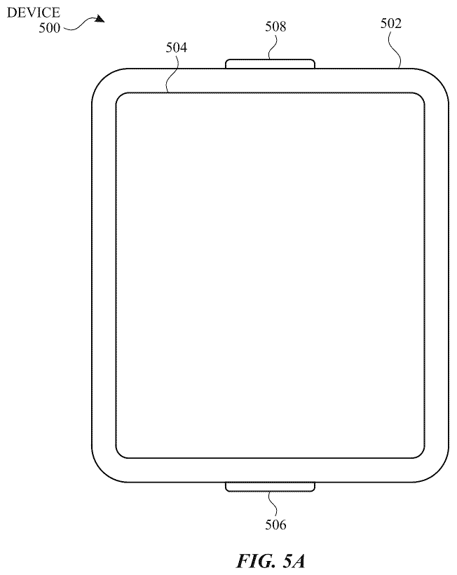

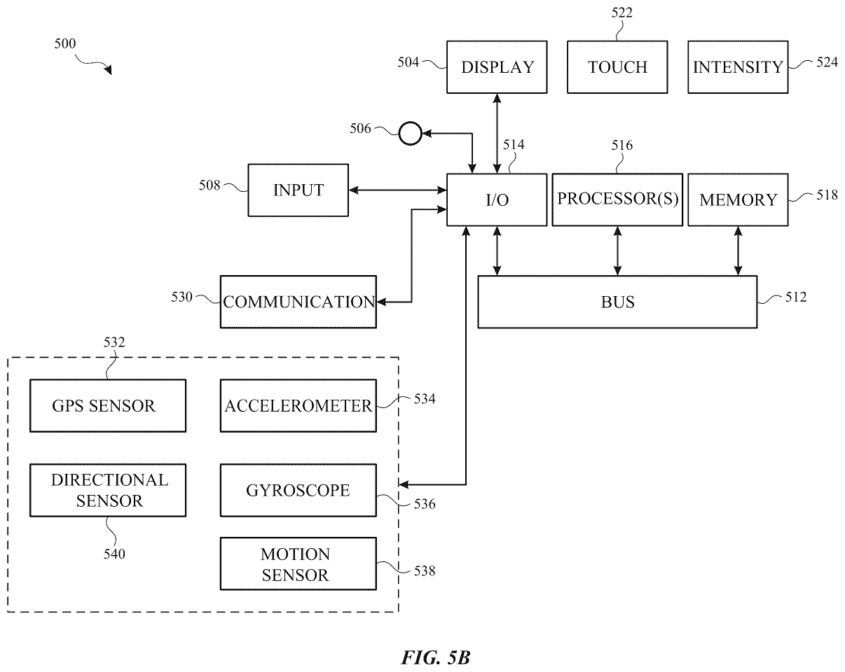

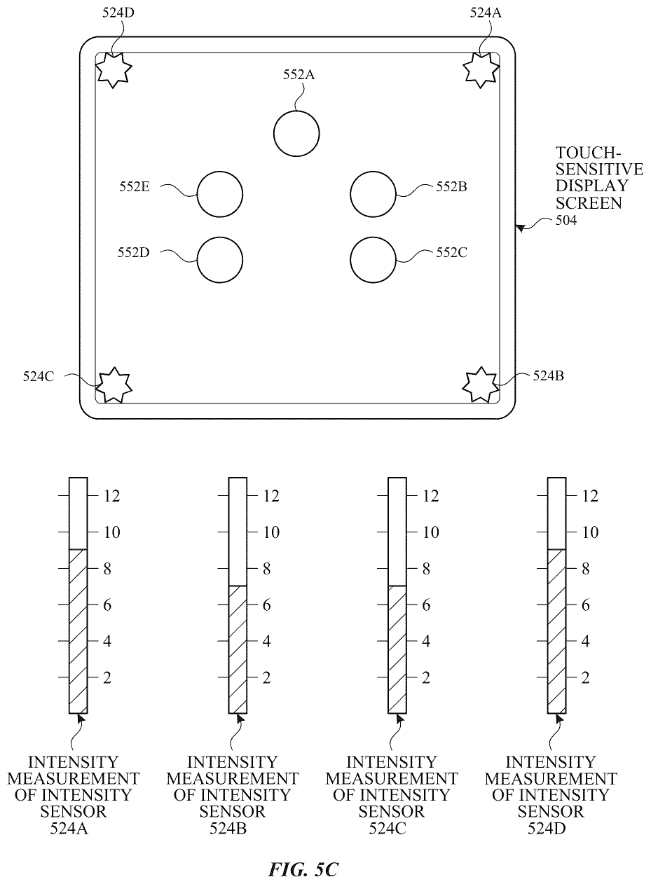

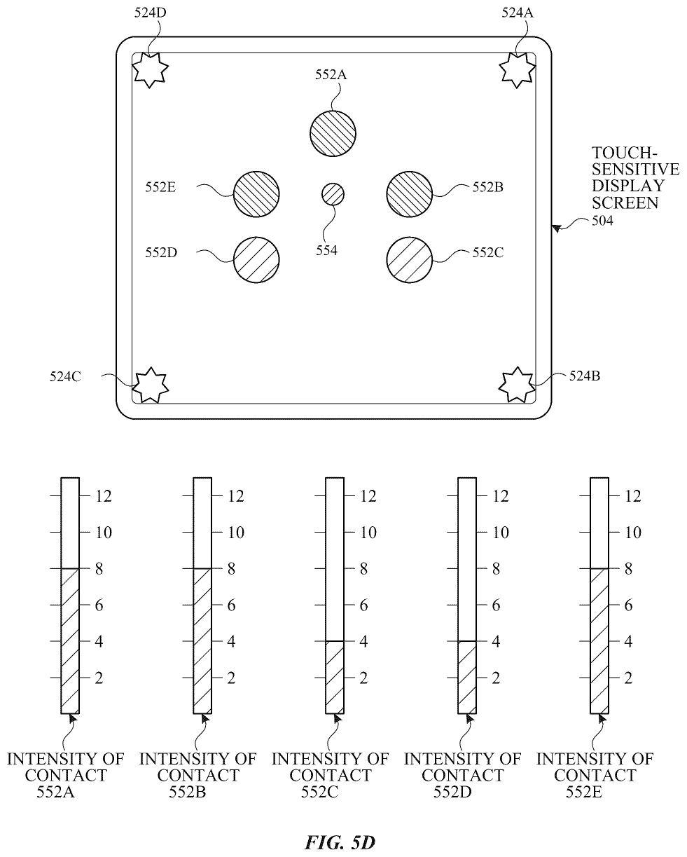

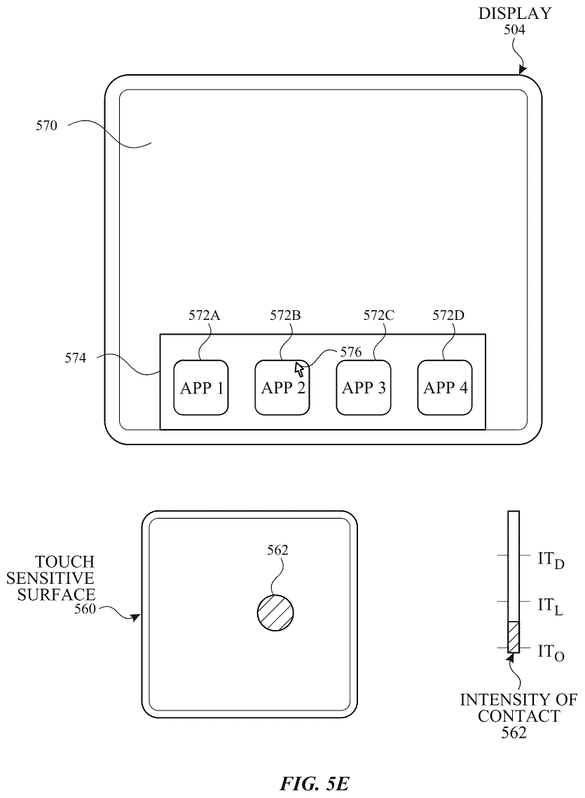

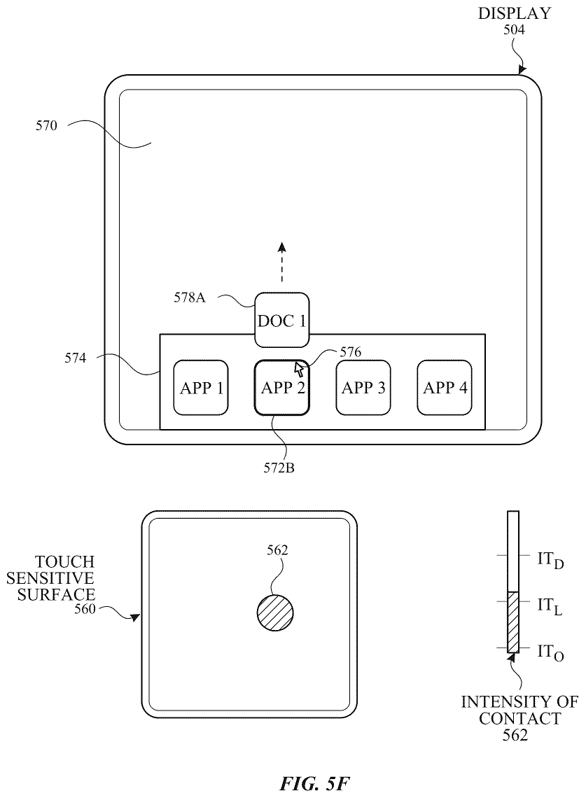

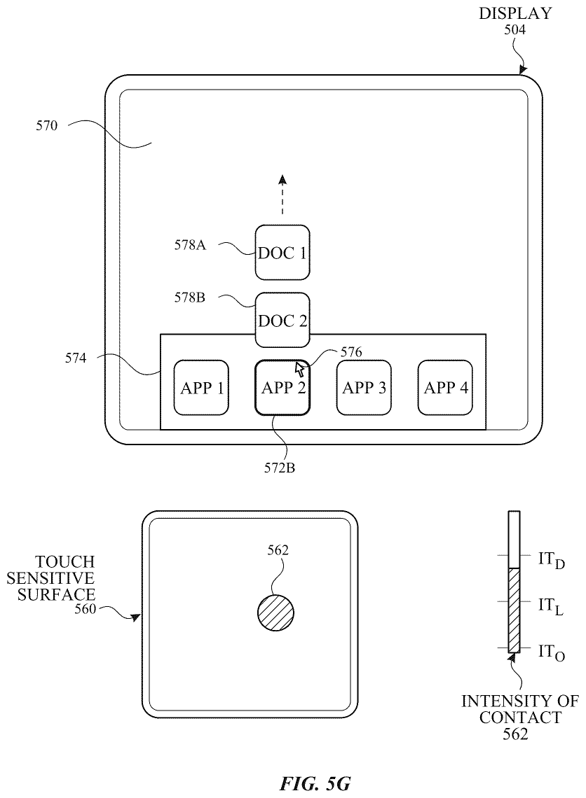

FIG. 5A illustrates a block diagram of an exemplary architecture for the device 500 according to some embodiments of the disclosure. In the embodiment of FIG. 5A, media or other content is optionally received by device 500 via network interface 502, which is optionally a wireless or wired connection. The one or more processors optionally execute any number of programs stored in memory 506 or storage, which optionally includes instructions to perform one or more of the methods and/or processes described herein (e.g., method 700). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIGS. 5, but can include other or additional components in multiple configurations.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

FIG. 5C illustrates detecting a plurality of contacts 552A-552E on touch-sensitive display screen 504 with a plurality of intensity sensors 524A-524D. FIG. 5C additionally includes intensity diagrams that show the current intensity measurements of the intensity sensors 524A-524D relative to units of intensity. In this example, the intensity measurements of intensity sensors 524A and 524D are each 9 units of intensity, and the intensity measurements of intensity sensors 524B and 524C are each 7 units of intensity. In some implementations, an aggregate intensity is the sum of the intensity measurements of the plurality of intensity sensors 524A-524D, which in this example is 32 intensity units. In some embodiments, each contact is assigned a respective intensity that is a portion of the aggregate intensity. FIG. 5D illustrates assigning the aggregate intensity to contacts 552A-552E based on their distance from the center of force 554. In this example, each of contacts 552A, 552B, and 552E are assigned an intensity of contact of 8 intensity units of the aggregate intensity, and each of contacts 552C and 552D are assigned an intensity of contact of 4 intensity units of the aggregate intensity. More generally, in some implementations, each contact j is assigned a respective intensity Ij that is a portion of the aggregate intensity, A, in accordance with a predefined mathematical function, Ij=A·(Dj/ΣDi), where Dj is the distance of the respective contact j to the center of force, and ΣDi is the sum of the distances of all the respective contacts (e.g., i=1 to last) to the center of force. The operations described with reference to FIGS. 5C-5D can be performed using an electronic device similar or identical to device 100, 300, or 500. In some embodiments, a characteristic intensity of a contact is based on one or more intensities of the contact. In some embodiments, the intensity sensors are used to determine a single characteristic intensity (e.g., a single characteristic intensity of a single contact). It should be noted that the intensity diagrams are not part of a displayed user interface, but are included in FIGS. 5C-5D to aid the reader.

In some embodiments, a portion of a gesture is identified for purposes of determining a characteristic intensity. For example, a touch-sensitive surface optionally receives a continuous swipe contact transitioning from a start location and reaching an end location, at which point the intensity of the contact increases. In this example, the characteristic intensity of the contact at the end location is, optionally, based on only a portion of the continuous swipe contact, and not the entire swipe contact (e.g., only the portion of the swipe contact at the end location). In some embodiments, a smoothing algorithm is, optionally, applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is, optionally, characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

FIGS. 5E-5H illustrate detection of a gesture that includes a press input that corresponds to an increase in intensity of a contact 562 from an intensity below a light press intensity threshold (e.g., “IT_{L}”) in FIG. 5E, to an intensity above a deep press intensity threshold (e.g., “IT_{D}”) in FIG. 5H. The gesture performed with contact 562 is detected on touch-sensitive surface 560 while cursor 576 is displayed over application icon 572B corresponding to App 2, on a displayed user interface 570 that includes application icons 572A-572D displayed in predefined region 574. In some embodiments, the gesture is detected on touch-sensitive display 504. The intensity sensors detect the intensity of contacts on touch-sensitive surface 560. The device determines that the intensity of contact 562 peaked above the deep press intensity threshold (e.g., “IT_{D}”). Contact 562 is maintained on touch-sensitive surface 560. In response to the detection of the gesture, and in accordance with contact 562 having an intensity that goes above the deep press intensity threshold (e.g., “IT_{D}”) during the gesture, reduced-scale representations 578A-578C (e.g., thumbnails) of recently opened documents for App 2 are displayed, as shown in FIGS. 5F-5H. In some embodiments, the intensity, which is compared to the one or more intensity thresholds, is the characteristic intensity of a contact. It should be noted that the intensity diagram for contact 562 is not part of a displayed user interface, but is included in FIGS. 5E-5H to aid the reader.

In some embodiments, the display of representations 578A-578C includes an animation. For example, representation 578A is initially displayed in proximity of application icon 572B, as shown in FIG. 5F. As the animation proceeds, representation 578A moves upward and representation 578B is displayed in proximity of application icon 572B, as shown in FIG. 5G. Then, representations 578A moves upward, 578B moves upward toward representation 578A, and representation 578C is displayed in proximity of application icon 572B, as shown in FIG. 5H. Representations 578A-578C form an array above icon 572B. In some embodiments, the animation progresses in accordance with an intensity of contact 562, as shown in FIGS. 5F-5G, where the representations 578A-578C appear and move upwards as the intensity of contact 562 increases toward the deep press intensity threshold (e.g., “IT_{D})”). In some embodiments, the intensity, on which the progress of the animation is based, is the characteristic intensity of the contact. The operations described with reference to FIGS. 5E-5H can be performed using an electronic device similar or identical to device 100, 300, or 500.

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed towards embodiments of user interfaces (“UI”) and associated processes that are implemented on an electronic device, such as device 100, device 300, or device 500.

### User Interfaces and Associated Processes

### Displaying Indications of Playback State and Playback Position of a Content Item in User Interfaces of a Content Application

Users interact with electronic devices in many different manners. In some embodiments, an electronic device presents a user interface of a content application. In some embodiments, the user interface includes a user interface element indicating a playback state and playback position of a content item playing or paused using the content application. The embodiments described below provide ways in which an electronic device presents the user interface element in multiple user interfaces of the content application and interactions with the user interface element. The ability of an electronic device to display the user interface element reduces the amount of time needed by a user to view relevant information about the content item, thus reducing power usage of the electronic device. When a person uses an electronic device, that person is optionally referred to as a user of the electronic device.

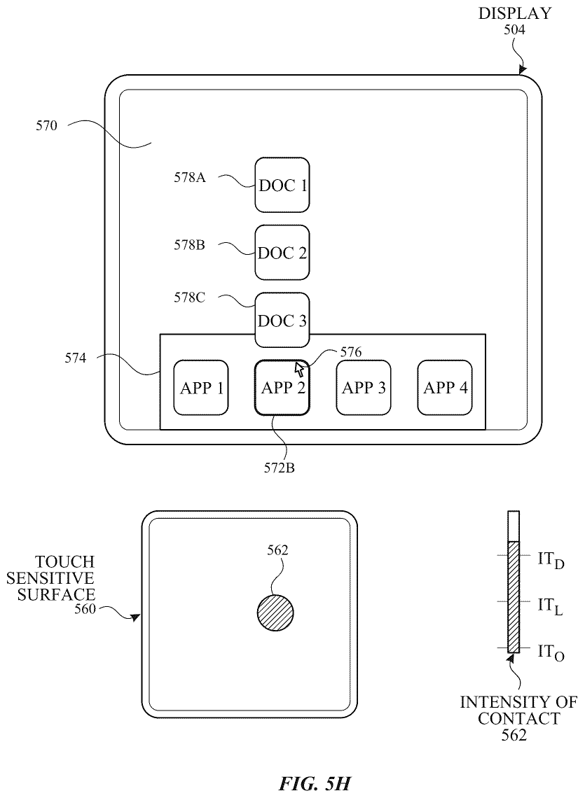

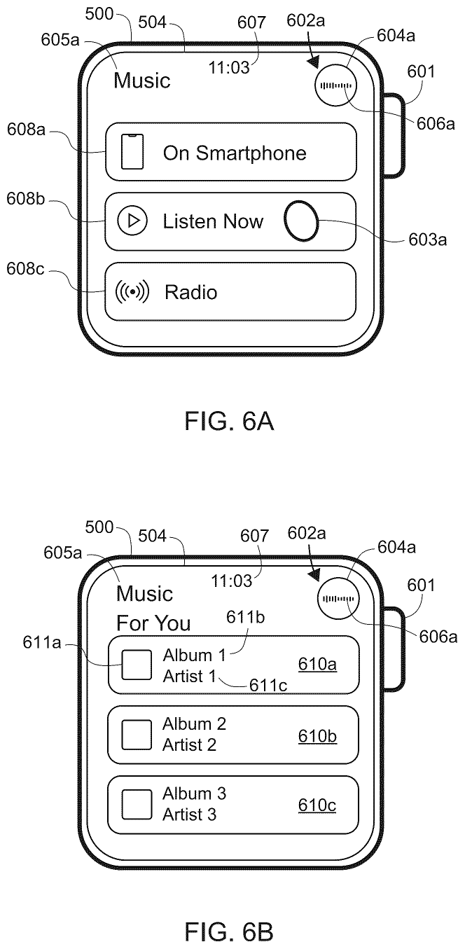

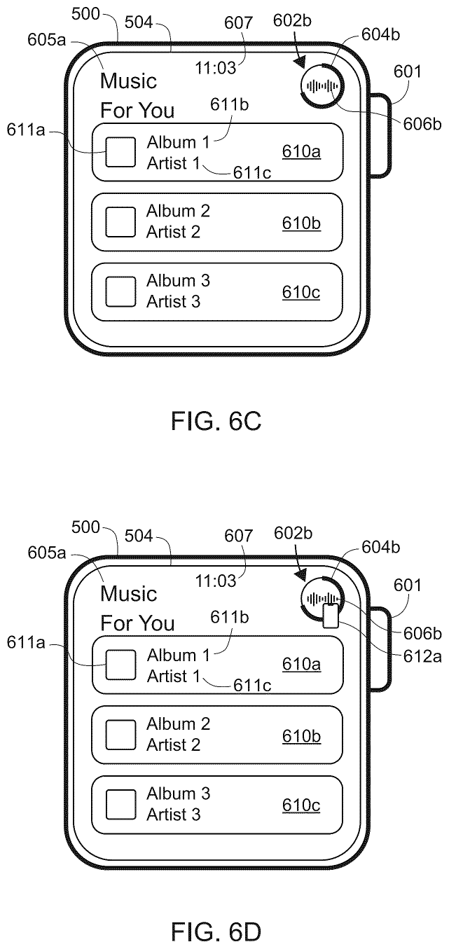

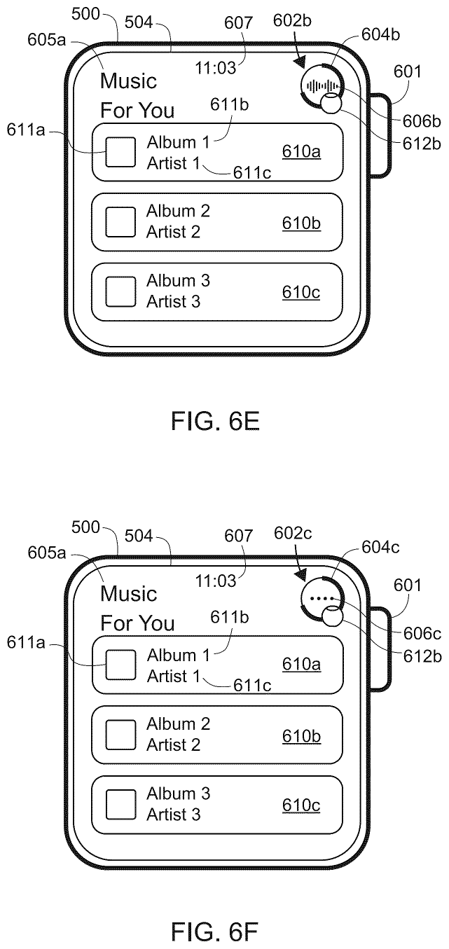

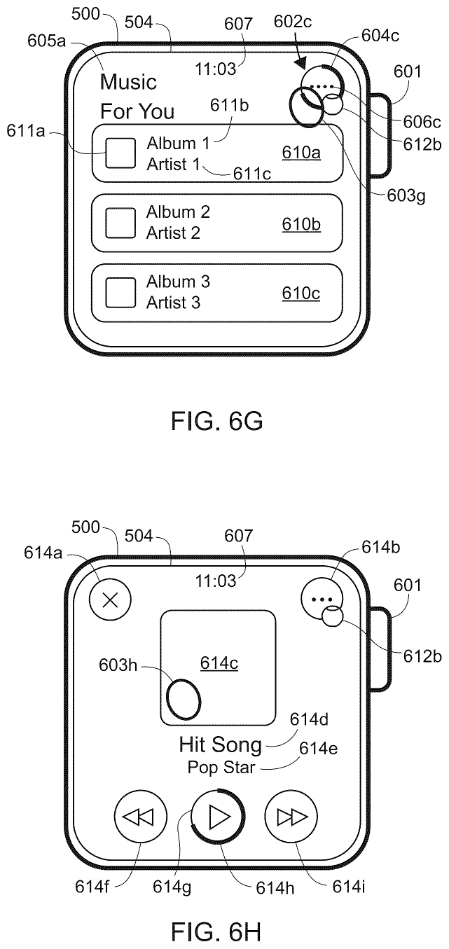

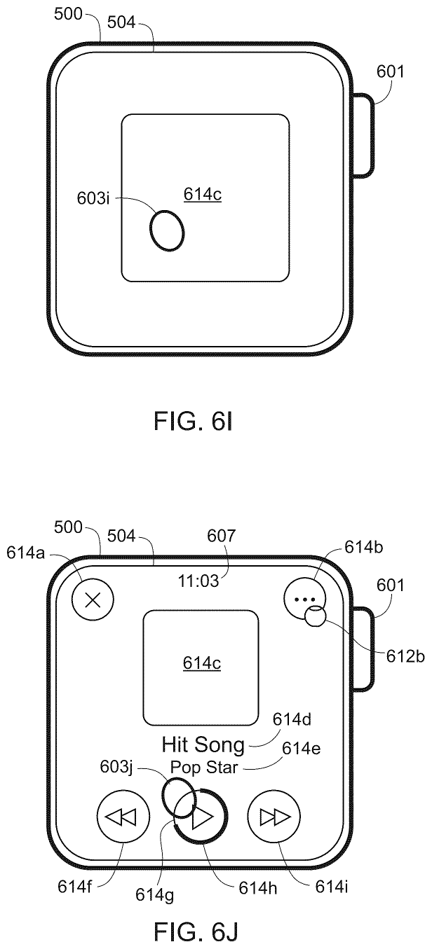

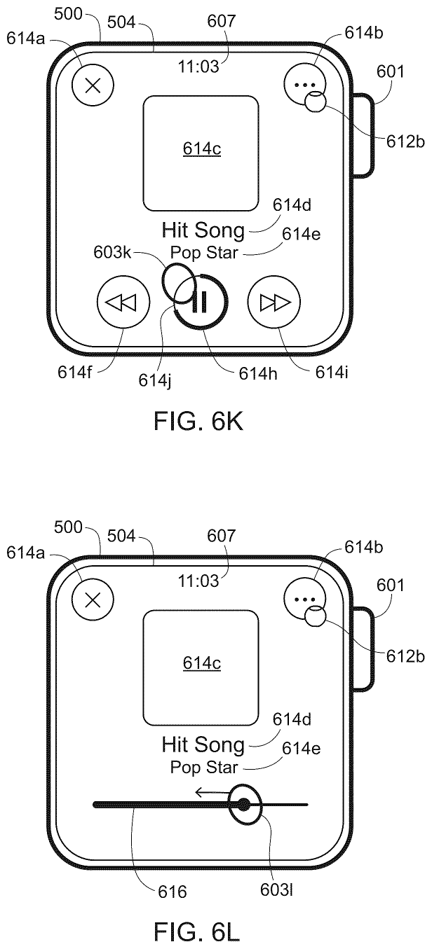

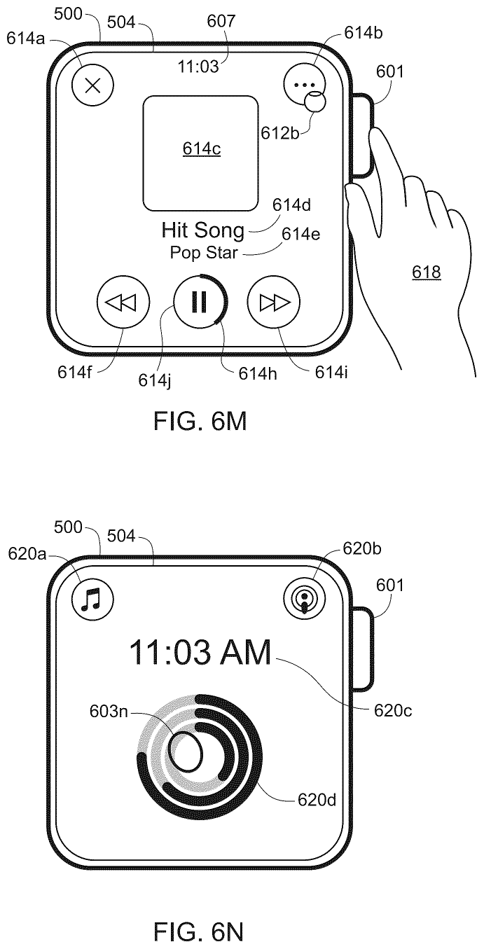

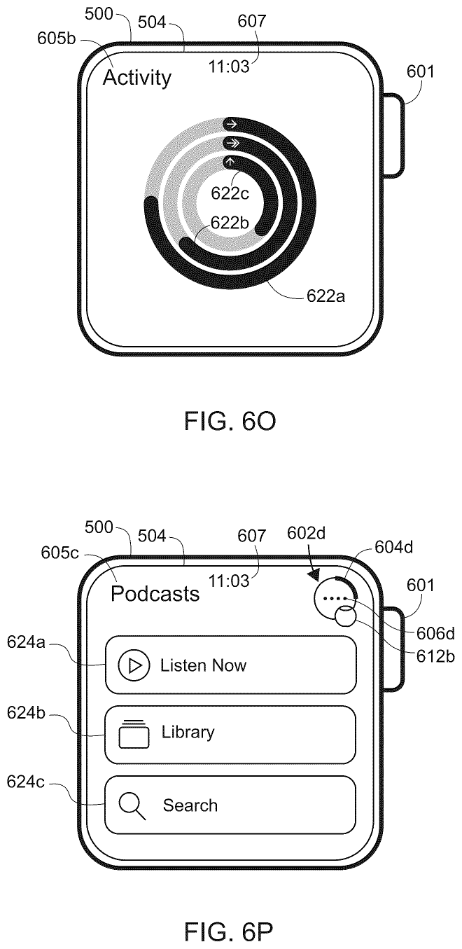

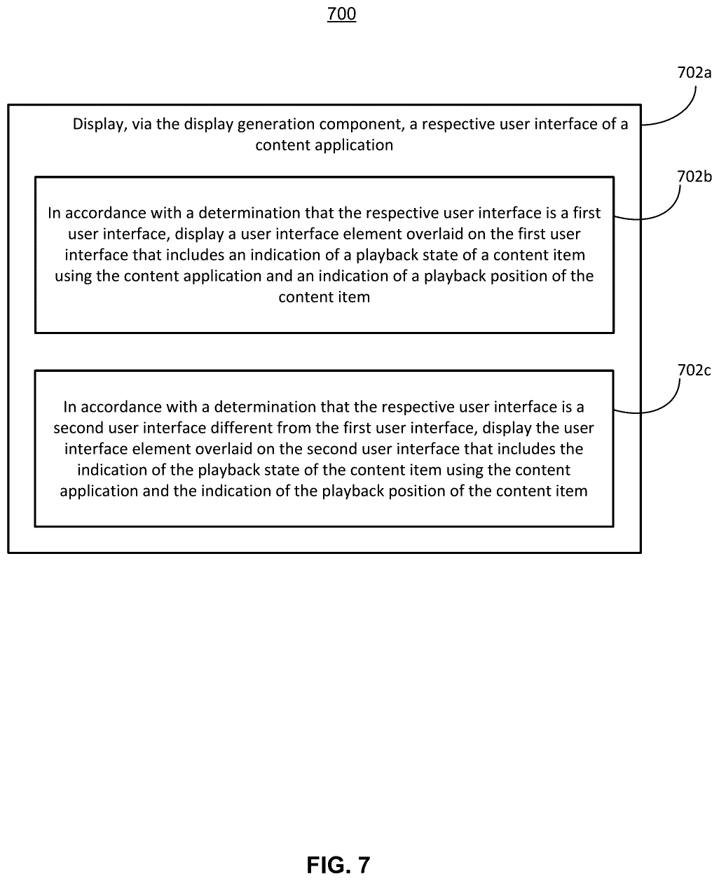

FIGS. 6A-6P illustrate examples of an electronic device 500 displaying a user interface element with information about a content item playing or paused using a content application according to some embodiments of the disclosure. The embodiments in these figures are used to illustrate the processes described below, including the processes described with reference to FIG. 7. These figures are not meant to be limiting; other user interfaces are possible in accordance with method 700 without departing from the scope of the disclosure.

In some embodiments, electronic device 500 includes one or more content applications for browsing, organizing, sharing, and/or playing content items of a respective type. For example, the electronic device 500 includes a music application, an audiobooks application, and/or a podcast application. In some embodiments, the user interfaces of the content applications include a user interface element indicating the playback state (e.g., paused, playing, or no content paused or playing) and playback position of a content item associated with the content application. For example, the electronic device 500 displays a user interface element indicating a playback state and playback position of a music content item in a plurality of user interfaces of the music application and the electronic device 500 displays a user interface element indicating a playback state and playback position of a podcast content item in a plurality of user interfaces of the podcast application. In some embodiments, in response to receiving an input selecting the user interface element, the electronic device 500 displays a user interface that includes a different indication of playback state of the content item, a different indication of playback position of the content item, one or more additional indications related to the content item, and/or one or more options for controlling playback of the content item. In some embodiments, the user interface displayed in response to receiving the input selecting the user interface element does not include the user interface element.

FIG. 6A illustrates electronic device 500 displaying a user interface (e.g., via a display device, via a display generation component, or via a touch screen 504). In some embodiments, user interface 600 is displayed via a display generation component. In some embodiments, the display generation component is a hardware component (e.g., including electrical components) capable of receiving display data and displaying a user interface. In some embodiments, examples of a display generation component include a touch screen display (such as touch screen 504), a monitor, a television, a projector, an integrated, discrete, or external display device, or any other suitable display device that is in communication with device 500. In some embodiments, device 500 is a wearable device such as a smart watch. In some embodiments, the electronic device 500 includes a crown 601. The electronic device 500 can receive inputs directed to the crown 601, such as inputs that press the crown 601 like a button and inputs that turn the crown 601 like a dial.

In FIG. 6A, the electronic device 500 displays a user interface of a content application according to some embodiments. For example, the content application is a music application. Examples described herein with reference to the music application can apply to other types of content applications without departing from the scope of the disclosure. As shown in FIG. 6A, the content application user interface includes an indication 605a of the name of the application, an indication 607 of the current time, a user interface element 602a indicating information about playback state of the music application, and selectable options 608a through 608c. In some embodiments, while displaying the user interface shown in FIG. 6A, the electronic device 500 is not playing or pausing a content item using the content application (e.g., the content application player is “empty”). Accordingly, as shown in FIG. 6A, the user interface element 602a includes an indication 606a that there is no content item playing or paused with the content application and an indication 604a that there is no playback position of a content item with the content application, because there is no content item playing or paused with the content application. In some embodiments, there is no content item playing or paused with the content application because there are no content items saved in a library of the content application, because playback of a content item (or collection of content items, such as an album or playlist) has concluded, or because the electronic device 500 has not played content items with the content application before or in a predetermined amount of time (e.g., 4, 6, 12, or 18 hours or 1, 2, 3, 5, 7, or 14 days). In some embodiments, as will be described in more detail below, while the playback state of the content application is playing or paused, the electronic device 500 updates the user interface element 602a to reflect the playback state and to indicate a playback position of the content item that is playing or paused with the content application.

In some embodiments, options 608a through 608c, when selected, cause the electronic device 500 to navigate to different user interfaces of the content application. For example, in response to receiving an input selecting option 608a, the electronic device 500 displays a user interface including indications of content items stored on a second electronic device (e.g., a smartphone) in communication with the electronic device 500. As another example, in response to receiving an input selecting option 608c, the electronic device 500 displays a user interface for browsing radio stations and/or initiates playback of content items streamed using a radio station. As shown in FIG. 6A, the electronic device 500 receives an input selecting (e.g., with contact 603a) option 608b. In response to the input shown in FIG. 6A, the electronic device 500 displays a user interface of the content application including representations of content items curated for the user, as shown in FIG. 6B.

FIG. 6B illustrates the electronic device 500 displaying a user interface of the content application including representations 610a through 610c of content items recommended to the user. In some embodiments, the electronic device 500 displays the user interface shown in FIG. 6B in response to receiving the input illustrated in FIG. 6A. In some embodiments, the electronic device 500 recommends content items represented by representations 610a through 610c based on content consumption history of the user. For example, the electronic device 500 recommends content items similar to content items the user has previously consumed and/or rated favorably (e.g., by leaving a positive rating or review or adding to a list of favorite or “loved” content items). As another example, the electronic device 500 recommends content items consumed by or rated favorably by other users with similar content consumption history and/or ratings history as the user of the electronic device 500. As shown in FIG. 6B, representation 610a includes an image 611a corresponding to the content item, an indication 611b of the title of the content item, and an indication 611c of an artist associated with the content item. Representations 610b and 610c can include similar elements as the elements of representation 610a. As shown in FIG. 6B, the representations 610a through 610c can correspond to collections of content items, such as an album including a plurality of songs. In some embodiments, the user interface including indications of content items recommended for the user can include representations of individual content items (e.g., individual songs, podcasts, or audiobooks) or different collections of content items (e.g., playlists, series).

As shown in FIG. 6B, while displaying the user interface including the representations 610a through 610c of content items recommended to the user, the electronic device 500 maintains display of the user interface element 602a that was displayed in the user interface in FIG. 6B. In some embodiments, the user interface element 602a in FIG. 6B includes the same elements as the user interface element 602a in FIG. 6A and is displayed at the same location of display generation component 504 in FIG. 6B as was the case in FIG. 6A. In some embodiments, the electronic device 500 maintains display of the user interface element 602a in a plurality of user interfaces of the content application at the same location and with the same elements.

FIG. 6C illustrates the electronic device 500 displaying a user interface similar to the user interface described above with reference to FIG. 6B, but different in that user interface element 602b indicates that the content application is currently playing a content item. In some embodiments, user interface element 602b indicates the content application is playing a content item with indication 606b, which can be animated, unlike indication 606a in user interface element 602a, which is not animated. Additionally, in some embodiments, the indication 606b includes an indication 604b of the current playback position of the content item playing with the content application. In some embodiments, indication 604b updates as the content item plays in accordance with playback of the content item. For example, indication 604b progresses to cover a larger portion of the perimeter around indication 606b as the playback position progresses, with an empty ring corresponding to the very beginning of the content item and a full ring corresponding to the very end of the content item. In some embodiments, if the electronic device 500 was playing a content item while displaying the user interface shown in FIG. 6A, the electronic device 500 would display user interface element 602b in the user interface shown in FIG. 6A instead of displaying user interface element 602a in the user interface.

In some embodiments, while the electronic device 500 is connected to a respective output device (e.g., an audio output device such as speakers, headphones, earbuds, or another electronic device) satisfying one or more criteria, the electronic device 500 displays a visual indication illustrating the respective output device overlaid on user interface element 602b. For example, in FIG. 6C, the electronic device 500 is not connected to an output device meeting the one or more criteria, so user interface element 602b does not include an indication of an output device. In some embodiments, the one or more criteria for displaying an indication of an output device are satisfied when the output device is connected to the electronic device 500 through another electronic device and/or is included in a first predetermined list of specific models of output devices or a predetermined list of types of output devices and/or is excluded from a second predetermined list of specific models of output devices or a predetermined list of types of output devices. For example, the electronic device 500 forgoes displaying an indication of an output device while playing content using speakers integrated with the electronic device 500 or using wireless (e.g., Bluetooth) headphones or earbuds in communication with the electronic device 500 without being in communication with the electronic device 500 through another electronic device.

FIG. 6D illustrates an example of the electronic device 500 displaying an indication 612a of an output device being used to play a content item with the content application overlaid on the user interface element 602b. For example, indication 612a is an indication illustrating a smartphone that the electronic device 500 displays while controlling playback of a content item with the content application that is being played using speakers integrated with the smartphone. As shown in FIG. 6D, the indication 612a is an image (e.g., icon, drawing, cartoon, illustration, and/or photograph) of the smartphone. In the example shown in FIG. 6D, the electronic device 500 is playing a content item with the content application, so user interface element 602b includes an animated indication 606b that the content item is playing and an indication 604b of the current playback position of the content item that updates as the content item plays. It should understood that, in some embodiments, the electronic device 500 displays the indication 612a of the smartphone in a manner similar to display of the indication 612a in FIG. 6D in different user interfaces of the content application and/or overlaid on user interface element 602a indicating no content item is playing and/or overlaid on user interface element 602c indicating the content item is paused, described in more detail below in at least FIG. 6F, in response to the electronic device 500 controlling playback of content using the smartphone.

FIG. 6E illustrates an example of the electronic device 500 displaying an indication 612b of another output device being used to play a content item with the content application overlaid on the user interface element 602b. For example, indication 61ba is an indication illustrating a smart speaker that the electronic device 500 displays while controlling playback of a content item with the content application that is being played using the smart speaker. As shown in FIG. 6E, the indication 612b is an image (e.g., icon, drawing, cartoon, illustration, and/or photograph) of the smart speaker. In the example shown in FIG. 6E, the electronic device 500 is playing a content item with the content application, so user interface element 602b includes an animated indication 606b that the content item is playing and an indication 604b of the current playback position of the content item that updates as the content item plays. It should understood that, in some embodiments, the electronic device 500 displays the indication 612b of the smart speaker in a manner similar to display of the indication 612b in FIG. 6E in different user interfaces of the content application and/or overlaid on user interface element 602a indicating no content item is playing and/or overlaid on user interface element 602c indicating the content item is paused, described in more detail below in at least FIG. 6F, in response to the electronic device 500 controlling playback of content using the smart speaker.

In addition to displaying the indication 612a of the smartphone or the indication 612b of the smart speaker, in some embodiments, the electronic device 500 displays indications illustrating other types of output devices while the electronic device 500 is controlling playback of content on the output device using the content application. For example, the electronic device 500 displays indications of headphones connected to the electronic device 500 through another electronic device, such as displaying an indication of a set of headphones while the electronic device 500 controls playback of a content item playing on another electronic device (e.g., a smartphone) that outputs audio using the headphones. In some embodiments, the electronic device 500 displays different indications of different models of output devices in the same category, such as displaying a different indication from indication 612b when playing the content item using a different model of smart speaker. In some embodiments, the electronic device 500 displays the same indications when connected to different models of the same types of output devices, such as displaying indication 612b irrespective of whether the electronic device 500 is playing content using a first model of smart speaker or a second model of smart speaker. In some embodiments, the electronic device 500 can display these indications in a variety of user interfaces of the content application and/or overlaid on user interface element 602a, user interface element 602b, and/or user interface element 602c.

FIG. 6F illustrates an example of the electronic device 500 displaying user interface element 602c overlaid on the user interface of the content application while the content item is paused using the content application. For example, the user interface element 602c includes an indication 606c that the content item is paused with the content application and indication 604c of the playback position of the content item at which the content item is paused. In some embodiments, indication 606c is not animated and includes an image different from indication 606a included in the indication 606a displayed when there is not content item playing or paused with the content application. In some embodiments, indication 604c does not change over time, because the playback position of the content item does not change while the content item is paused. As shown in FIG. 6F, the electronic device 500 displays the indication 612b of the smart speaker overlaid on user interface element 602c because the electronic device 500 is connected to the smart speaker. In some embodiments, the electronic device 500 would forgo displaying the indication 612b if the electronic device 500 was not connected to the smart speaker, such as displaying an indication of a different output device to which the electronic device 500 is connected or not displaying an indication of an output device as described herein. In some embodiments, the electronic device 500 displays the user interface element 602c in other user interfaces of the content application while displaying those user interfaces and while the content item is paused, such as in the user interface shown in FIG. 6A.

FIG. 6G illustrates the same user interface shown in FIG. 6F. In FIG. 6G, the electronic device 500 receives an input selecting the user interface element 602c (e.g., with contact 603g). In response to receiving the input in FIG. 6G, the electronic device 500 displays the user interface shown in FIG. 6H. It should be understood that, in some embodiments, the electronic device 500 would display the user interface in FIG. 6H in response to an input selecting user interface element 602a or 602b. It should be understood that, in some embodiments, the electronic device 500 would display the user interface in FIG. 6H in response to an input selecting user interface element 602a, 602b, or 602c displayed in a user interface other than the user interface in FIG. 6G (e.g., the user interface in FIG. 6A). It should be understood that, in some embodiments, the electronic device 500 would display the user interface in FIG. 6H in response to an input selecting user interface element 602a, 602b, or 602c while the electronic device 500 displays an indication of a different output device similar to indication 612b or while the electronic device 500 does not display an indication of an output device.

FIG. 6H illustrates the electronic device 500 displaying a user interface with additional information about the content item currently paused with the content application in response to the input illustrated in FIG. 6G, for example. The user interface in FIG. 6H includes an option 614a to cease display of the user interface and, optionally, to navigate back to the previously displayed user interface, such as the user interface in FIG. 6G. The user interface in FIG. 6H includes an indication 607 of the current time. The user interface in FIG. 6H includes a selectable option 614b that, when selected, causes the electronic device 500 to display a menu including options for performing actions related to the content item, such as sharing the content item with another user, adding the content item to a library or a list of favorite or “loved” content items, and/or viewing a user interface with more information about the content item. In some embodiments, the electronic device 500 displays the indication 612b of the smart speaker overlaid on option 614b because the electronic device 500 is connected to the smart speaker. In some embodiments, the electronic device 500 would forgo display of indication 612b if the electronic device 500 were not connected to the smart speaker, optionally including displaying a different indication if the electronic device 500 was connected to a different output device. The user interface in FIG. 6H includes an image 614c associated with the content item (e.g., album artwork, show artwork, or a book cover), an indication 614d of the name of the content item, and/or an indication 614e of the artist of the content item. The user interface in FIG. 6H includes an option 614f to skip back in a queue of content items or within the content item and an option 614i to skip ahead in a queue of content items or within the content item. While the content item is paused, the user interface in FIG. 6H includes an indication 614h of the playback position of the content item that does not advance because the playback position of the content item does not change while the content item is paused and an option 614g to transition from pausing the content item to playing the content item. In some embodiments while the content item is playing, the user interface in FIG. 6H includes an indication of the playback position of the content item that advances in accordance with playback of the content item and an option to transition from playing the content item to pausing the content item, as shown in FIG. 6K.

As shown in FIG. 6H, the electronic device does not display user interface element 602a, 602b, or 602c in the user interface. Instead, for example, the electronic device 500 indicates the playback state of the content item with option 614g and indicates the playback position of the content item with option 614g. As shown in FIG. 6H, the electronic device 500 maintains display of the indication 612b at the same location in FIG. 6H as the location of the indication 612b in FIG. 6G. In FIG. 6H, the indication 612b is overlaid on the menu option 614b. As shown in FIG. 6H, the electronic device 500 receives an input selecting the image 614c associated with the content item (e.g., with contact 603h). In response to receiving the input shown in FIG. 6H, the electronic device 500 displays the user interface in FIG. 6I.

FIG. 6I illustrates an example of the electronic device 500 displaying the image 614c associated with the content item without displaying other user interface elements of FIG. 6H in response to receiving the input illustrated in FIG. 6H. As shown in FIG. 6I, the electronic device 500 displays the image 614c at a larger size in FIG. 6I than the size of image 614c in FIG. 6H. In some embodiments, the electronic device 500 maintains display of a subset of other elements of the user interface in FIG. 6H in addition to the image 614c in response to the input illustrated in FIG. 6H. In some embodiments, the electronic device 500 displays the image 614c without displaying other user interface elements as shown in FIG. 6I in response to receiving the input illustrated in FIG. 6H. As shown in FIG. 6H, the electronic device 500 receives an input selecting the image 614c (e.g., with contact 603i). In some embodiments, in response to the input illustrated in FIG. 6I, the electronic device 500 displays the user interface in FIG. 6J, which can be the same as the user interface in FIG. 6H.

FIG. 6J illustrates the electronic device 500 displaying the same user interface as the user interface described previously with reference to FIG. 6H in response to receiving the input shown in FIG. 6I. As shown in FIG. 6J, the electronic device 500 receives an input selecting the play option 614g (e.g., with contact 603j). In response to receiving the input shown in FIG. 6J, the electronic device 500 plays the content item and updates the user interface as shown in FIG. 6K.

FIG. 6K illustrates the electronic device 500 displaying the updated user interface in response to receiving the input illustrated in FIG. 6J. In some embodiments, the electronic device 500 plays the content item in response to the input in FIG. 6J and updates the user interface to include an option 614j to pause the content item and updates the indication 614h of the current playback position of the content item to update in accordance with the playback position updating during playback of the content item. In some embodiments, the input illustrated in FIG. 6J is a primary selection input described in more detail with reference to method 700. In FIG. 6K, the electronic device 500 receives an input selecting option 614j (e.g., with contact 603k) with a secondary selection described in more detail below with reference to method 700. In some embodiments, in response to the input illustrated in FIG. 6K, the electronic device 500 initiates scrubbing of the content item, as shown in FIG. 6L.

FIG. 6L illustrates the electronic device 500 enabling scrubbing of the playback position of the content item in response to the input illustrated in FIG. 6K. For example, as shown in FIG. 6L, in response to receiving the input in FIG. 6K, the electronic device 500 displays a scrubber bar 616 interactive to scrub the playback position of the content item. In some embodiments, instead of displaying scrubber bar 616, the electronic device 500 displays one or more selectable options for scrubbing forwards and/or backwards, optionally at a variety of scrubbing speeds (e.g., 25×, 0.5×, 1.5×, 2×, 3×, 5×, and/or 10× speed). In some embodiments, the electronic device 500 does not display user interface elements for scrubbing the content item in response to the input illustrated in FIG. 6K, but scrubs the playback position of the content item in accordance with further movement of contact 603k. In some embodiments, the electronic device 500 receives an input scrubbing the playback position of the content item back (e.g., with contact 603l). In response to the input shown in FIG. 6L, the electronic device 500 updates the playback position of the content item, as shown in FIG. 6M.

FIG. 6M illustrates an example of the electronic device 500 updating the user interface after scrubbing the playback position of the content item in response to receiving the input illustrated in FIG. 6L. For example, in FIG. 6M, the indication 614h of the playback position indicates a playback position earlier in the content item than the playback position represented by indication 614h in FIG. 6K. In FIG. 6M, the electronic device 500 receives an input directed to the crown 601, such as the user 618 pressing the crown 601 like a button. In some embodiments, in response to receiving the input shown in FIG. 6M, the electronic device 500 displays a home screen user interface of the electronic device 500, as shown in FIG. 6N.

FIG. 6N illustrates the electronic device 500 displaying the home screen user interface in response to receiving the input in FIG. 6M. As shown in FIG. 6N, the home screen user interface does not include user interface element 602a, 602b, or 602c because the home screen user interface is not a user interface of the content application. In some embodiments, the home screen user interface includes an option 620a to display a user interface of the content application (e.g., the music application), an option 620b to display a user interface of a different content application (e.g., a podcast application), an indication 620c of the current time, and a user interface element 620d of an activity tracking application. In some embodiments, the home screen user interface may include elements of different applications or different elements of the applications displayed herein, or may include elements in a different arrangement or style than those illustrated in FIG. 6N, but would still not include user interface element 602a, 602b, and/or 602c. As shown in FIG. 6N, the electronic device 500 receives an input selecting the user interface element 620d (e.g., with contact 603n). In response to receiving the input illustrated in FIG. 6N, the electronic device 500 displays a user interface of the activity tracking application, as shown in FIG. 6O.

FIG. 6O illustrates the electronic device 500 displaying the user interface of the activity application in response to receiving the input illustrated in FIG. 6N. As shown in FIG. 6O, the activity tracking user interface does not include user interface element 602a, 602b, or 602c because the activity tracking user interface is not a user interface of the content application. In some embodiments, the electronic device 500 displays an indication 604b of the name of the activity application, an indication 607 of the current time, and indications 622a through 622c of various activity tracking parameters.

In some embodiments, the electronic device 500 displays indications similar to user interface elements 602a, 602b, and 602c in user interfaces of other content applications that reflect the playback status and playback position of a content item with the other content application. For example, in FIG. 6P, the electronic device 500 displays a user interface of a second content application (e.g., a podcast application) including user interface element 602d similar to user interface element 602c. In some embodiments, the electronic device 500 displays the user interface in FIG. 6P in response to receiving an input selecting option 620b in FIG. 6N.

In FIG. 6P, the user interface of the second content application includes an indication 605c of the name of the second content application, an indication 607 of a current time, and selectable options 624a through 624c. In some embodiments, in response to receiving an input selecting option 624a, the electronic device 500 displays representations of content items in a playback queue of the second content application. In some embodiments, in response to receiving an input selecting option 624b, the electronic device 500 displays representations of content items in a library of the second content application. In some embodiments, in response to receiving an input selecting option 624c, the electronic device 500 displays a user interface for searching for content items available in the second content application. As shown in FIG. 6P, the user interface includes user interface element 602d including an indication 606d that the second content application is paused and an indication 604d of the playback position of the content item paused with the second content item. In some embodiments, the user interface includes the indication 612b of the smart speaker while the electronic device 500 is connected to the smart speaker.

In some embodiments, while displaying the user interface of the second content application including the user interface element 602d that the content item of the second content application is paused, the electronic device 500 is playing content with a different content application, such as the content application described above with reference to FIGS. 6A-6M. The user interface element 602d indicates that the second content application is paused while the electronic device 500 is playing content, because the electronic device 500 is not playing content with the second content application, so the second content application is paused. In some embodiments, if the electronic device 500 were playing content with the second content application, the electronic device 500 would display an indication similar to user interface element 602b in the user interface of the second content application. In some embodiments, if there was no content item playing or paused with the second content application, the electronic device 500 would display an indication similar to user interface element 602a in the user interface of the second content application. In some embodiments, if the electronic device 500 was not connected to the smart speaker while displaying the user interface of the second content application, the user interface of the second content application would not include indication 612b, such as displaying an indication of a different output device or not displaying an indication of an output device as described herein.

FIG. 7 is a flow diagram illustrating a method in which an electronic device displays a user interface element with information about a content item playing or paused using a content application according to some embodiments of the disclosure. The method 700 is optionally performed at first and/or electronic devices such as device 100, device 300, or device 500 as described above with reference to FIGS. 1A-1B, 2-3, 4A-4B and 5A-5C. Some operations in method 700 are, optionally combined and/or order of some operations is, optionally, changed.

In some embodiments, method 700 is performed at an electronic device in communication with one or more input devices and a display generation component. For example, the electronic device is a mobile device (e.g., a tablet, a smartphone, a media player, or a wearable device) including wireless communication circuitry, optionally in communication with one or more of a mouse (e.g., external), trackpad (optionally integrated or external), touchpad (optionally integrated or external), remote control device (e.g., external), another mobile device (e.g., separate from the electronic device), a handheld device (e.g., external), and/or a controller (e.g., external), etc.). In some embodiments, the display generation component is a display integrated with the electronic device (optionally a touch screen display), external display such as a monitor, projector, television, or a hardware component (optionally integrated or external) for projecting a user interface or causing a user interface to be visible to one or more users, etc.

In some embodiments, the electronic device displays (702a), via the display generation component, a respective user interface of a content application, such as one of the user interfaces illustrated in FIGS. 6A and/or 6B.

In some embodiments, in accordance with a determination that the respective user interface is a first user interface, the electronic device displays (702b) a user interface element overlaid on the first user interface that includes an indication of a playback state of a content item using the content application and an indication of a playback position of the content item, such as user interface element 602a in FIG. 6A. In some embodiments, the content application is a content browsing, playback, and/or sharing application, such as a music, podcasts, and/or audiobooks application. In some embodiments, the respective user interface (e.g., the first user interface or the second user interface described below) is a user interface for browsing content items available through the content application. For example, the respective user interface is a user interface including representations of content items in a collection (e.g., album, playlist, and/or series). In some embodiments, as described in more detail below, the electronic device forgoes display of the user interface element while displaying a user interface including information about a content item that is currently playing or paused using the content application that includes a different indication of the playback state and playback position, in addition to other elements such as a title, artist, collection, and/or artwork associated with the content item and/or user interface elements such as a skip ahead option, a skip back option, and/or a play/pause option. In some embodiments, as described below, in response to receiving an input selecting the user interface element, the electronic device displays the user interface including information about the content item that is currently playing or paused. In some embodiments, while the content item is playing using the content application, the user interface element includes an animated indication. In some embodiments, while the content item is paused, the user interface element includes a static (e.g., not animated) indication. In some embodiments, while there is no content item currently playing or paused that is associated with the content application, the user interface element includes a static (e.g., not animated) indication different from the static indication displayed while there is a paused content item. For example, the static indication associated with the paused content item and the static indication associated with no content item playing or paused differ in size, color, design, pattern, and/or translucency. In some embodiments, while the content item is paused, the indication of the playback position is not animated. In some embodiments, while the content item is playing, the indication of the playback position is animated in accordance with progress from the beginning of the content item to the end of the content item. For example, the indication of the playback position of the content item is a partial circle that progresses from a point to a full circle as the content item plays. In some embodiments, while there is no content item playing or paused using the content application, the indication of the playback position is replaced with a static indication that looks different from the playback indication, such as a circle with a different line style than the line style of the partial circle included in the indication of the playback position previously described.

In some embodiments, in accordance with a determination that the respective user interface is a second user interface different from the first user interface, the electronic device displays (802c) the user interface element overlaid on the second user interface that includes the indication of the playback state of the content item using the content application and the indication of the playback position of the content item, such as user interface element 602a in FIG. 6B. In some embodiments, the electronic device navigates between the first and second user interfaces in response to receiving one or more inputs directed to the respective user interface of the content application. In some embodiments, the user interface element is displayed at the same location relative to the respective user interface of the content application regardless of whether the electronic device displays the first user interface or the second user interface (or another user interface). In some embodiments, while displaying a user interface of a different content application, the electronic device displays another user interface element including an indication of the playback state of the other content application and an indication of playback position of a content item of the other content application. In some embodiments, while displaying a user interface of a different content application, the electronic device displays the user interface element associated with the other content application at the same location relative to the user interface of the other content application as the location of the user interface element relative to the user interface of the content application. As described in more detail below, in some embodiments, the user interface element of the content application is independent from the corresponding user interface element of the other content application. Displaying the user interface element indicating the playback state and playback position of the content item in the first user interface of the content application and the second user interface of the content application enhances user interactions with the electronic device by reducing the number of inputs needed to view information about the playback state and playback position of the content item playing or paused with the content application while the user browses other user interfaces of the content application.

In some embodiments, while displaying the respective user interface of the content application and the user interface element that includes the indication of the playback state of the content item using the content application and the indication of the playback position of the content item, the electronic device receives, via the one or more input devices, an input selecting the user interface element, such as selection of user interface element 602c with contact 603g in FIG. 6G. In some embodiments, receiving the input includes detecting a contact at a location of a touch screen with which the user interface element is displayed. In some embodiments, receiving the input includes detecting activation of a hardware input device (e.g., detecting the press of a button or key or a click of a mouse while the user interface element has the input focus of the electronic device). In some embodiments, receiving the input includes detecting (e.g., with one or more cameras and/or depth sensors) the user perform a gesture with their arms, hands, and/or fingers. In some embodiments, receiving the input includes detecting (e.g., with a gaze tracking device) the gaze and/or attention (e.g., gaze for more than a threshold amount of time, such as 0.1, 0.2, 0.3, 0.5, 1, 2, 3 or 5 seconds) of the user directed to the user interface element.

In some embodiments, in response to receiving the input selecting the user interface element, the electronic device ceases display of the respective user interface of the content application and the user interface element, such in FIG. 6H in which user interface element 602c from FIG. 6G is not displayed. In some embodiments, the third user interface, described in more detail below, includes a different representation of the current playback position of the content item and a different indication of the playback state of the content item than the indication of the playback position of the content item and the indication of the playback state of the content item included in the user interface element.

In some embodiments, in response to receiving the input selecting the user interface element, the electronic device displays, via the display generation component, a third user interface of the content application that includes information about the content item and one or more selectable options that, when selected, cause the electronic device to modify playback of the content item, such as the user interface in FIG. 6H. In some embodiments, the third user interface includes the title, artist, content item collection (e.g., album, playlist, or series) including the content item, artwork associated with the content item, a skip ahead option, a skip back option, a play/pause option, and an option to view a menu with more options for performing actions related to the content item. In some embodiments, while displaying the third user interface, the electronic device forgoes display of the user interface element including the indication of the playback state of the content item with the content application and the indication of the playback progress of the content item with the content application that was displayed concurrently with the respective user interface. Displaying the third user interface in response to detecting selection of the user interface element enhances user interactions with the electronic device by reducing the number of inputs needed to access the information and options related to the content item.

In some embodiments, the third user interface includes an image associated with the content item, such as image 614c in FIG. 6H. In some embodiments, the image is associated with a collection of content items including the content item, such as an album, playlist, or podcast series. In some embodiments, the image is associated with the content item itself, such as a book cover of an audiobook.

In some embodiments the electronic device receives, via the one or more input devices, an input selecting the image associated with the content item, such as selection of image 614c with contact 603h in FIG. 6H. In some embodiments, the electronic device receives the input selecting the image in a manner similar to the manner described above of receiving the input selecting the user interface element.

In some embodiments, in response to receiving the input selecting the image associated with the content item, the electronic device ceases display of the information about the content item and the one or more selectable options that, when selected, cause the electronic device to modify playback of the content item, such as in FIG. 6I in which user interface elements 614d through 614i in FIG. 6H are not displayed. In some embodiments, in response to receiving the input selecting the image associated with the content item, the electronic device displays the image associated with the content item without displaying other elements of the third user interface. In some embodiments, in response to receiving the input selecting the image associated with the content item, the electronic device maintains display of one or more system user interface elements, such as the current time, an indication of the name of the content application, and/or a selectable option that, when selected, causes the electronic device to navigate back to a previously-displayed user interface (e.g., the third user interface or the respective user interface of the content application).

In some embodiments, in response to receiving the input selecting the image associated with the content item, the electronic device maintaining display, via the display generation component, of the image associated with the content item, such as image 614c in FIG. 6I. In some embodiments, in response to receiving the input, the electronic device maintains display of the image including maintaining the appearance of the image. In some embodiments, in response to receiving the input, the electronic device maintains display of the image including updating a visual characteristic of the image, such as size, opacity, and/or colors (e.g., saturation, contrast, and/or hues). For example, in response to receiving the input, the electronic device increases the size of the image associated with the content item. In some embodiments, in response to receiving an input selecting the image while displaying the image associated with the content item without displaying the information about the content item and the one or more selectable options, the electronic device resumes display of the third user interface including the information about the content item and the one or more selectable options. In some embodiments, the electronic device displays a user interface including information about the content item and/or one or more selectable options that, when selected, cause the electronic device to modify playback of the content item in response to receiving an input selecting the user interface element. In some embodiments, in response to detecting an input directed to the image associated with the content item, the electronic device ceases display of user interface elements other than the image and maintains display of the image. Ceasing display of the information and the one or more selectable options and maintaining display of the image associated with the content item in response to the input selecting the image associated with the content item enhances user interactions with the electronic device by reducing visual clutter and/or freeing up more display area to display the image at a larger size.

In some embodiments, the one or more selectable options that, when selected, cause the electronic device to modify playback of the content item include a first option, such as option 614g in FIG. 6J. In some embodiments, the first option is a play/pause option, as described in more detail below.

In some embodiments, the electronic device receives, via the one or more input devices, an input selecting the first option, such as in FIG. 6J in which option 614g is selected with contact 603j. In some embodiments, the electronic device receives the input selecting the first option in a manner similar to the manner described above of receiving the input selecting the user interface element.

In some embodiments, in response to receiving the input selecting the first option, in accordance with a determination that the input satisfies one or more criteria, the electronic device toggles a play state and a pause state of the content item, such as playing the content item in FIG. 6K in response to the input in FIG. 6J. In some embodiments, the input satisfies the one or more criteria when the input is a primary selection input, such as a tap in which a contact is detected with a touch screen for less than a threshold amount of time (e.g., 0.1, 0.2, 0.3, 0.5, 1, 2, or 3 seconds), a left mouse click, a single-finger tap on a trackpad, and/or detecting a mouse click without concurrently detecting activation of a keyboard key (e.g., command or control key). In some embodiments, while the content item is paused, the first option includes a “play” icon or indication (e.g., an image or text) and, in response to detecting selection of the first option, the electronic device plays the content item (e.g., from the playback position at which the content item was paused and/or scrubbed to). In some embodiments, while the content item is playing, the first option includes a “pause” icon or indication (e.g., an image or text) and, in response to detecting selection of the first option, the electronic device pauses the content item (e.g., at the playback position at which the content item was playing when the input was received).

In some embodiments, in response to receiving the input selecting the first option, in accordance with a determination that the input fails to satisfy the one or more criteria (or the input satisfies one or more second criteria different from the one or more criteria), the electronic device initiates control of a playback position of the content item by scrubbing, such as in FIG. 6L in response to the input illustrated in FIG. 6K. In some embodiments, in response to receiving the input and in accordance with a determination that the input fails to satisfy the one or more criteria, the electronic device displays one or more user interface elements for scrubbing the playback position of the content item with the content application. In some embodiments, the input fails to satisfy the one or more criteria, or satisfies the one or more second criteria, when the input is a secondary selection input, such as a tap in which a contact is detected with a touch screen for more than a threshold amount of time described above, a right mouse click, a multi (e.g., double)-finger tap on a trackpad, and/or detecting a mouse click while concurrently detecting activation of a keyboard key (e.g., command or control key). In some embodiments, in response to detecting the input that fails to satisfy the one or more criteria, the electronic device displays a scrubber bar with which the user can interact to scrub the playback position of the content item. In some embodiments, in response to detecting the input that fails to satisfy the one or more criteria, the electronic device displays an option to scrub the playback position backwards and/or an option to scrub the playback position forwards. In some embodiments, the option to scrub the playback position backwards displayed in response to receiving the input is different from the option to skip back displayed prior to receiving the input. In some embodiments, the option to scrub the playback position forwards displayed in response to receiving the input is different from the option to skip ahead displayed prior to receiving the input. In some embodiments, in response to receiving the input selecting the first option that does not satisfy the one or more criteria, the electronic device forgoes displaying additional user interface elements for controlling scrubbing of the content item and enables control of the scrubbing based on further input, such as scrubbing the content item back in response to detecting movement of a contact on a touch screen in a first direction (e.g., to the left) and/or scrubbing the content item forward in response to detecting movement of a contact on a touch screen in a second direction (e.g., to the right). In some embodiments, in response to receiving the input selecting the first option that does not satisfy the one or more criteria, the electronic device provides feedback to the user other than displaying options and/or indications, such as outputting an audio and/or tactile indication. In some embodiments, in response to detecting an input that fails to satisfy the one or more criteria that is detected to the play/pause option, the electronic device displays one or more user interface elements for scrubbing the playback position of the content item. Displaying the one or more user interface elements that scrub the playback position of the content item in response to receiving the input that fails to satisfy the one or more criteria enhances user interactions with the electronic device by providing additional functionality without cluttering the display with more displayed options.

In some embodiments, the input selecting the user interface element is directed to a first portion of the user interface element, such as in FIG. 6G. In some embodiments, the input has one or more of the characteristics described above. In some embodiments, the input is detected using a touch screen detecting a contact and the contact is detected at the location of the first portion of the user interface element. In some embodiments, the input is a mouse click while a cursor points to the first portion of the user interface element.

In some embodiments, while displaying the respective user interface of the content application and the user interface element that includes the indication of the playback state of the content item using the content application and the indication of the playback position of the content item, the electronic device receives, via the one or more input devices, an input selecting a second portion of the user interface element different from the first portion of the user interface element, such as an input directed to indication 602c in FIG. 6G, but at a different position of indication 602c than the position of contact 603g in FIG. 6G.

In some embodiments, in response to receiving the input selecting the second portion of the user interface element, the electronic device ceases display of the respective user interface of the content application and the user interface element, such as displaying the user interface in FIG. 6H without indication 602c in FIG. 6G. In some embodiments, the input has one or more of the characteristics described above. In some embodiments, the input is detected using a touch screen detecting a contact and the contact is detected at the location of the second portion of the user interface element. In some embodiments, the input is a mouse click while a cursor points to the second portion of the user interface element.

In some embodiments, in response to receiving the input selecting the second portion of the user interface element, the electronic device displays, via the display generation component, the third user interface of the content application that includes the information about the content item and the one or more selectable options that, when selected, cause the electronic device to modify playback of the content item, such as the user interface in FIG. 6H including elements 614c through 614i. For example, the first portion or second portion is one of the indication of the current playback state of the content item, the indication of the playback position of the content item, and/or the visual indication of the output device described below. In some embodiments, in response to detecting the input selecting the user interface element, the electronic device displays the third user interface irrespective of the portion of the user interface element to which the input was directed. Displaying the third user interface in response to the input directed to the user interface elements regardless of the portion of the user interface element to which the input was directed enhances user interactions with the electronic device by reducing the opportunity for user error.

In some embodiments, while displaying the respective user interface of the content application and the user interface element that includes the indication of the playback state of the content item using the content application and the indication of the playback position of the content item, in accordance with a determination that the electronic device is in communication with an output device that satisfies one or more criteria, the electronic device displays, via the display generation component, a visual indication of the output device that satisfies the one or more criteria overlaid on the user interface element, such as visual indication 612a in FIG. 6D. In some embodiments, the output device includes a speaker. In some embodiments, the output device satisfies one or more criteria when the output device is included in a first predetermined list of output devices or excluded from a second predetermined list of output devices. In some embodiments, the output device satisfies one or more criteria when the output device is another electronic device (e.g., a smartphone) or in communication with the electronic device through the other electronic device, such as a speaker or headphones connected to the other electronic device. In some embodiments, the electronic device displays the visual indication of the output device regardless of whether the content is played or paused or there is not content item playing or paused with the content application, as described below. For example, if the content item is paused or there is no content item playing or paused, the visual indication of the output device indicates the output device that would be used to play a content item if the electronic device initiates playback of a content item (e.g., in response to one or more inputs). In some embodiments, if the content item is playing, the visual indication of the content item indicates the output device being used to play the content item.

In some embodiments, while displaying the respective user interface of the content application and the user interface element that includes the indication of the playback state of the content item using the content application and the indication of the playback position of the content item, in accordance with a determination that the electronic device is in communication with an output device that fails to satisfy the one or more criteria, the electronic device forgoes displaying, via the display generation component, a visual indication of the output device that fails to satisfy the one or more criteria, such as the lack of display of indication 612a in FIG. 6D in the user interface of FIG. 6C. In some embodiments, the output device includes a speaker. In some embodiments, the output device fails to satisfy the one or more criteria when the output device is included in a first predetermined list of output devices or excluded from a second predetermined list of output devices. For example, the one or more criteria are not satisfied when the electronic device is playing content though speakers integrated with the electronic device or Bluetooth headphones connected to the electronic device and the one or more criteria are satisfied when the electronic device is playing content through other output devices, such as Bluetooth speakers other than headphones, another electronic device (e.g., a smartphone) and/or Bluetooth speakers or headphones connected to the other electronic device. In some embodiments, the electronic device displays a visual indication when the electronic device is playing content using an output device that satisfies one or more criteria and forgoes displaying the visual indication when the electronic device is playing content using an output device that fails to satisfy the one or more criteria. Displaying the indication of the output device that satisfies one or more criteria enhances user interactions with the electronic device by reducing the number of inputs needed to troubleshoot audio output by providing information about the output device to which the electronic device is connected.

In some embodiments, while displaying the respective user interface of the content application and the user interface element that includes the indication of the playback state of the content item using the content application and the indication of the playback position of the content item, in accordance with a determination that the electronic device is in communication with a first output device that satisfies one or more criteria, the electronic device displays, via the display generation component, a first visual indication of the first output device overlaid on the user interface element, wherein the first visual indication illustrates the first output device, such as visual indication 612a in FIG. 6D. In some embodiments, the visual indication is an image, such as a photo, cartoon, or icon depicting the appearance of the output device.

In some embodiments, while displaying the respective user interface of the content application and the user interface element that includes the indication of the playback state of the content item using the content application and the indication of the playback position of the content item, in accordance with a determination that the electronic device is in communication with a second output device that satisfies the one or more criteria that is different from the first output device, the electronic device displays, via the display generation component, a second visual indication of the second output device overlaid on the user interface element, wherein the second visual indication illustrates the second output device and the second visual indication is different from the first visual indication, such as visual indication 612b in FIG. 6E. In some embodiments, the visual indication is an image, such as a photo, cartoon, or icon depicting the appearance of the output device. In some embodiments, the electronic device is able to display indications illustrating a plurality of different output devices, such as particular models and/or classes of output devices, such as Bluetooth headphones, Bluetooth speakers, smartphones, set top boxes and/or particular models thereof. In some embodiments, while the electronic device is connected to an output device for which the electronic device does not have a corresponding visual indication, the electronic device displays an image corresponding to a plurality of different output devices that do not have a corresponding visual indication. In some embodiments, while connected to an output device that satisfies the one or more criteria, the electronic device displays a visual indication illustrating the output device. Displaying the indication of the output device that illustrates the output device enhances user interactions with the electronic device by reducing the number of inputs needed to troubleshoot audio output by providing information about the output device to which the electronic device is connected.

In some embodiments, while displaying the respective user interface of the content application and the user interface element that includes the indication of the playback state of the content item using the content application and the indication of the playback position of the content item and while displaying the visual indication of the output device overlaid on the user interface element, the electronic device receives, via the one or more input devices, an input selecting the user interface element, such as selection of user interface element 602c with contact 603g in FIG. 6G. In some embodiments, the electronic device receives the input selecting the user interface element in the manner described above.

In some embodiments, in response to receiving the input selecting the user interface element, the electronic device ceases display of the respective user interface of the content application and the user interface element, such as in the user interface in FIG. 6H which does not include the user interface element 602c from FIG. 6G.

In some embodiments, in response to receiving the input selecting the user interface element, the electronic device displays, via the display generation component, a third user interface of the content application that includes information about the content item, one or more selectable options that, when selected, cause the electronic device to modify playback of the content item, and the visual indication of the output device, such as displaying visual indication 612b overlaid on option 614b in FIG. 6H. In some embodiments, the third user interface has the elements and/or characteristics described above. In some embodiments, the visual indication of the output device is displayed overlaid on a selectable option included in the third user interface, such as an option to view a menu including additional selectable options for performing additional operations related to the content item that is playing or paused. In some embodiments, while displaying the third user interface, the electronic device displays the menu option at the location at which the user interface element had been displayed overlaid on the respective user interface. In some embodiments, the electronic device displays the visual indication of the output device at the same location in the third user interface as the location at which the visual indication was displayed in the respective user interface. In some embodiments, in response to detecting selection of the user interface element while the electronic device is not displaying the visual indication of the output device overlaid on the user interface element, the electronic device displays the third user interface without the visual indication of the output device. In some embodiments, in response to detecting the input selecting the user interface element that includes the visual indication of the output device overlaid on the user interface element, the electronic device displays the third user interface including the visual indication of the output device. Displaying the indication of the output device that illustrates the output device in the third user interface enhances user interactions with the electronic device by reducing the number of inputs needed to troubleshoot audio output by providing information about the output device to which the electronic device is connected.

In some embodiments, the electronic device displays, via the display generation component, a respective user interface of a second content application different from the content application, such as the user interface in FIG. 6P corresponding to a different application than the user interface in FIG. 6A. In some embodiments, the electronic device is capable of playing a variety of content items using different applications. For example, the content application and/or the second content application are one of a music application, a podcast application, and/or an audiobooks application. In some embodiments, the respective user interface of the second content application is a user interface other than a user interface including information about the content item and one or more selectable options that, when selected, cause the electronic device to modify playback of the content item with the second content application (e.g., a user interface of the second content application corresponding to the third user interface of the content application described above).

In some embodiments, in accordance with a determination that the respective user interface of the second content application is a first user interface of the second content application, the electronic device displays a second user interface element overlaid on the first user interface of the second content application that includes an indication of a playback state of a second content item using the second content application and an indication of a playback position of the second content item, such as displaying user interface element 602d in FIG. 6P. In some embodiments, the second user interface element of the second content application has a similar appearance as the appearance of the user interface element of the content application. For example, if the playback state and relative playback position of a content item playing with the content application is the same as the playback state and relative playback position of a content item playing with the second content application, the user interface element of the content application and the second user interface element of the second content application would look the same. In some embodiments, the second user interface element of the second content application has one or more characteristics of the user interface element of the content application.

In some embodiments, in accordance with a determination that the respective user interface of the second content application is a second user interface of the second content application different from the first user interface of the second content application, the electronic device displays the second user interface element overlaid on the second user interface of the second content application that includes the indication of the playback state of the second content item using the second content application and the indication of the playback position of the second content item, such as displaying user interface element 602df in FIG. 6P in a different user interface of the application than the user interface in FIG. 6P. In some embodiments, the electronic device displays the second user interface element of the second content application overlaid on one of a plurality of different user interfaces of the second content application. In some embodiments, the electronic device displays the second user interface element of the second content application at the same location at which the electronic device displays the user interface element of the content application. Displaying the second user interface element of the second content application enhances user interactions with the electronic device by reducing the number of inputs needed to view information about the playback state and playback position of the content item playing or paused with the content application while the user browses other user interfaces of the content application.

In some embodiments, while playing the content item using the content application and while the second content item is paused using the second content application, while displaying, via the display generation component, the respective user interface of the content application including the user interface element, the electronic device displays the user interface element with a visual indication that the content item is playing using the content application, such as user interface element 602b in FIG. 6D. In some embodiments, while displaying the respective user interface of the content application, the electronic device forgoes displaying the second user interface element of the second content application. In some embodiments, the user interface element reflects the playback status of the content item playing using the content application without reflecting the playback status of the second content item paused using the second content application. In some embodiments, while the content item is paused with the content application and while displaying the respective user interface of the content application, the electronic device displays the user interface element including a visual indication that the content item is paused irrespective of whether the second content item is playing or paused using the second content application, or whether there is no content item playing or paused using the second content application.

In some embodiments, while playing the content item using the content application and while the second content item is paused using the second content application, while displaying, via the display generation component, the respective user interface of the second content application including the second user interface element, the electronic device displays the second user interface element with a visual indication that the second content item is paused using the second content application, such as user interface element 602d in FIG. 6P. In some embodiments, while displaying the respective user interface of the second content application, the electronic device forgoes displaying the user interface element of the content application. In some embodiments, the second user interface element reflects the playback status of the second content item playing using the second content application without reflecting the playback status of the content item playing using the content application. In some embodiments, while the second content item is paused with the second content application and while displaying the respective user interface of the second content application, the electronic device displays the second user interface element including a visual indication that the content item is paused irrespective of whether the content item is playing or paused using the content application, or whether there is no content item playing or paused using the content application. In some embodiments, while the second content item is playing with the second content application, the content item is paused using the content application, and while displaying the respective user interface of the second content application, the electronic device displays the second user interface element including a visual indication that the content item is playing. Reflecting the playback status of the content application with the user interface element of the content application and reflecting the playback status of the second content application with the second user interface element of the second content application independent from each other enhances user interactions with the electronic device.

In some embodiments, the electronic device displays, via the display generation component, a respective user interface of an application other than the content application without displaying the user interface element, such as the user interface in FIG. 6O not including user interface element 602a, 602b, 602c, or 602d. In some embodiments, the electronic device navigates between the user interface of the content application and the user interface of the application other than the content application in response to receiving one or more user inputs. In some embodiments, the electronic device does not display the user interface element while displaying user interfaces other than user interfaces of the content application. In some embodiments, the electronic device forgoes displaying the user interface element while displaying a system user interface (e.g., a home screen user interface). In some embodiments, as described above, while displaying a user interface of a second content application, the electronic device forgoes displaying the user interface element of the content application, but may display the second user interface element of the second content application, as described above. In some embodiments, while concurrently displaying the respective user interface of the content application and the user interface of the application other than the content application, the electronic device displays the user interface element of the content application overlaid on the respective user interface of the content application, but not overlaid on the user interface of the application other than the content application. Forgoing display of the user interface element of the content application while displaying a user interface of another application enhances user interaction with the electronic device by conserving display area for user interface elements of the user interface of the other application.

In some embodiments, while displaying, via the display generation component, the respective user interface of the content application and while there is no content item playing or paused within the content application, the electronic device displays, via the display generation component, the user interface element overlaid on the respective user interface of the content application with the indication of the playback state of the content item corresponding to no content item playing or paused with the content application and the indication of the playback position corresponding to no content item playing or paused with the content application, such as user interface element 602a in FIG. 6A. In some embodiments, there is no content item playing or paused with the content application when the player is “in an empty state.” For example, there is no content item playing or paused with the content application when no content items have been played by the electronic device using the content application, when the content application does not have content items queued for playback, at the conclusion of a session of use with the content application, and/or when the content application first launches. In some embodiments, the visual indication of no content item playing or paused with the content application has a different appearance from the appearance of the indication of a content item playing with the content application and different from the appearance of the indication of a content item paused with the content application, as described in more detail above. Displaying the user interface element with the indication that there is no content item playing or paused with the content application enhances user interactions with the content application by reducing the number of inputs needed to view the playback status of the content application.

It should be understood that the particular order in which the operations in FIG. 7 have been described is merely exemplary and is not intended to indicate that the described order is the only order in which the operations could be performed. One of ordinary skill in the art would recognize various ways to reorder the operations described herein.

The operations in the information processing methods described above are, optionally, implemented by running one or more functional modules in an information processing apparatus such as general purpose processors (e.g., a as described with respect to FIGS. 1A-1B, 3, 5A-5J) or application specific chips. Further, the operations described above with reference to FIG. 7 are, optionally, implemented by components depicted in FIGS. 1A-1B. For example, displaying operations 702a, 702b, and/or 702c are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

As described above, one aspect of the present technology is collecting location information. The present disclosure contemplates that in some instances, the data utilized may include personal information data that uniquely identifies or can be used to contact or locate a specific person. Such personal information data can include demographic data, content consumption activity, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, collecting location information can be used to display maps of the physical area in which the electronic device is located. Accordingly, use of such personal information data enables users to use electronic devices to view maps of relevant geographic areas. Further, other uses for personal information data that benefit the user are also contemplated by the present disclosure. For instance, location data may be used to present navigation directions while the electronic device is traveling.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of location services, the present technology can be configured to allow users to select to “opt in” or “opt out” of participation in the collection of personal information data during registration for services or anytime thereafter. In another example, users can select not to enable location services in a specific application (e.g., first application and/or second application). In addition to providing “opt in” and “opt out” options, the present disclosure contemplates providing notifications relating to the access or use of personal information. For instance, a user may be notified upon initiating content collection that their personal information data will be accessed and then reminded again just before personal information data is accessed by the device(s).

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an electronic device displays maps of physical areas without sensing the current location of the electronic device.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

1. A method comprising:
at an electronic device in communication with one or more input devices and a display generation component:
displaying, via the display generation component, a respective user interface of a content application, wherein:
in accordance with a determination that the respective user interface is a first user interface, displaying a user interface element overlaid on the first user interface that includes an indication of a playback state of a content item using the content application and an indication of a playback position of the content item; and
in accordance with a determination that the respective user interface is a second user interface different from the first user interface, displaying the user interface element overlaid on the second user interface that includes the indication of the playback state of the content item using the content application and the indication of the playback position of the content item.

2. The method of claim 1, further comprising:
while displaying the respective user interface of the content application and the user interface element that includes the indication of the playback state of the content item using the content application and the indication of the playback position of the content item:
receiving, via the one or more input devices, an input selecting the user interface element; and in response to receiving the input selecting the user interface element:
ceasing display of the respective user interface of the content application and the user interface element; and
displaying, via the display generation component, a third user interface of the content application that includes information about the content item and one or more selectable options that, when selected, cause the electronic device to modify playback of the content item.

3. The method of claim 2, wherein the third user interface includes an image associated with the content item, and the method further comprises: receiving, via the one or more input devices, an input selecting the image associated with the content item; and
in response to receiving the input selecting the image associated with the content item:
ceasing display of the information about the content item and the one or more selectable options that, when selected, cause the electronic device to modify playback of the content item; and
maintaining display, via the display generation component, of the image associated with the content item.

4. The method of claim 2, wherein the one or more selectable options that, when selected, cause the electronic device to modify playback of the content item include a first option, and the method further comprises:
receiving, via the one or more input devices, an input selecting the first option; and
in response to receiving the input selecting the first option:
in accordance with a determination that the input satisfies one or more criteria, toggling a play state and a pause state of the content item; and
in accordance with a determination that the input fails to satisfy the one or more criteria, initiating control of a playback position of the content item by scrubbing.

5. The method of claim 2, wherein the input selecting the user interface element is directed to a first portion of the user interface element, and the method further comprises:
while displaying the respective user interface of the content application and the user interface element that includes the indication of the playback state of the content item using the content application and the indication of the playback position of the content item:
receiving, via the one or more input devices, an input selecting a second portion of the user interface element different from the first portion of the user interface element; and
in response to receiving the input selecting the second portion of the user interface element:
ceasing display of the respective user interface of the content application and the user interface element; and
displaying, via the display generation component, the third user interface of the content application that includes the information about the content item and the one or more selectable options that, when selected, cause the electronic device to modify playback of the content item.

6. The method of claim 1, further comprising:
while displaying the respective user interface of the content application and the user interface element that includes the indication of the playback state of the content item using the content application and the indication of the playback position of the content item:
in accordance with a determination that the electronic device is in communication with an output device that satisfies one or more criteria, displaying, via the display generation component, a visual indication of the output device that satisfies the one or more criteria overlaid on the user interface element; and
in accordance with a determination that the electronic device is in communication with an output device that fails to satisfy the one or more criteria, forgoing displaying, via the display generation component, a visual indication of the output device that fails to satisfy the one or more criteria.

7. The method of claim 6, further comprising:
while displaying the respective user interface of the content application and the user interface element that includes the indication of the playback state of the content item using the content application and the indication of the playback position of the content item:
in accordance with a determination that the electronic device is in communication with a first output device that satisfies one or more criteria, displaying, via the display generation component, a first visual indication of the first output device overlaid on the user interface element, wherein the first visual indication illustrates the first output device; and
in accordance with a determination that the electronic device is in communication with a second output device that satisfies the one or more criteria that is different from the first output device, displaying, via the display generation component, a second visual indication of the second output device overlaid on the user interface element, wherein the second visual indication illustrates the second output device and the second visual indication is different from the first visual indication.

8. The method of claim 6, further comprising:
while displaying the respective user interface of the content application and the user interface element that includes the indication of the playback state of the content item using the content application and the indication of the playback position of the content item and while displaying the visual indication of the output device overlaid on the user interface element:
receiving, via the one or more input devices, an input selecting the user interface element; and
in response to receiving the input selecting the user interface element:
ceasing display of the respective user interface of the content application and the user interface element; and
displaying, via the display generation component, a third user interface of the content application that includes information about the content item, one or more selectable options that, when selected, cause the electronic device to modify playback of the content item, and the visual indication of the output device.

9. The method of claim 1, further comprising:
displaying, via the display generation component, a respective user interface of a second content application different from the content application, wherein:
in accordance with a determination that the respective user interface of the second content application is a first user interface of the second content application, displaying a second user interface element overlaid on the first user interface of the second content application that includes an indication of a playback state of a second content item using the second content application and an indication of a playback position of the second content item; and
in accordance with a determination that the respective user interface of the second content application is a second user interface of the second content application different from the first user interface of the second content application, displaying the second user interface element overlaid on the second user interface of the second content application that includes the indication of the playback state of the second content item using the second content application and the indication of the playback position of the second content item.

10. The method of claim 9, further comprising:
while playing the content item using the content application and while the second content item is paused using the second content application:
while displaying, via the display generation component, the respective user interface of the content application including the user interface element, displaying the user interface element with a visual indication that the content item is playing using the content application; and
while displaying, via the display generation component, the respective user interface of the second content application including the second user interface element, displaying the second user interface element with a visual indication that the second content item is paused using the second content application.

11. The method of claim 1, further comprising:
displaying, via the display generation component, a respective user interface of an application other than the content application without displaying the user interface element.

12. The method of claim 1, further comprising:
while displaying, via the display generation component, the respective user interface of the content application and while there is no content item playing or paused within the content application:
displaying, via the display generation component, the user interface element overlaid on the respective user interface of the content application with the indication of the playback state of the content item corresponding to no content item playing or paused with the content application and the indication of the playback position corresponding to no content item playing or paused with the content application.

13. An electronic device in communication with a display generation component and one or more input devices:
one or more processors;
memory; and
one or more programs, wherein the one or more programs are stored in the memory and configured to be executed by the one or more processors, the one or more programs including instructions for:
displaying, via the display generation component, a respective user interface of a content application, wherein:
in accordance with a determination that the respective user interface is a first user interface, displaying a user interface element overlaid on the first user interface that includes an indication of a playback state of a content item using the content application and an indication of a playback position of the content item; and
in accordance with a determination that the respective user interface is a second user interface different from the first user interface, displaying the user interface element overlaid on the second user interface that includes the indication of the playback state of the content item using the content application and the indication of the playback position of the content item.

14. A non-transitory computer readable storage medium storing one or more programs, the one or more programs comprising instructions, which when executed by one or more processors of an electronic device in communication with a display generation component and one or more input devices, cause the electronic device to perform a method comprising:
displaying, via the display generation component, a respective user interface of a content application, wherein:
in accordance with a determination that the respective user interface is a first user interface, displaying a user interface element overlaid on the first user interface that includes an indication of a playback state of a content item using the content application and an indication of a playback position of the content item; and
in accordance with a determination that the respective user interface is a second user interface different from the first user interface, displaying the user interface element overlaid on the second user interface that includes the indication of the playback state of the content item using the content application and the indication of the playback position of the content item.
